(19) United States
(12) Patent Application Publication
(10) Pub. No.: US 2026/0012324 A1
(43) Pub. Date: Jan. 8, 2026

(54) UPLINK OPERATIONS FOR NETWORK CONTROLLED REPEATER (NCR) WITH TDD UL-DL CONFIGURATIONS

(71) Applicant: SHARP KABUSHIKI KAISHA, Sakai City, Osaka (JP)

(72) Inventors: ZHANPING YIN, Vancouver, WA (US); TOMOKI YOSHIMURA, Sakai City, Osaka (JP); KAI YING, Vancouver, WA (US)

(21) Appl. No.: 18/993,913

(22) PCT Filed: Aug. 3, 2023
(86) PCT No.: PCT/JP2023/028361

§ 371 Date: Jan. 13, 2025

Related U.S. Application Data
(60) Provisional application No. 63/396,898, filed on Aug. 10, 2022.

(51) Int. Cl. H04L 5/14; H04W 72/0446; H04W 72/12

(52) U.S. Cl. CPC H04L 5/1469; H04W 72/0446; H04W 72/12

(57) ABSTRACT

A network controlled repeater (NCR) is described. The NCR may include receiving circuitry configured to receive a cell specific common time division duplex (TDD) uplink/downlink (UL/DL) configuration and a side information with an NCR dedicated TDD UL/DL configuration, determine candidate slots for uplink (UL) reception on an access link, receive an indication from a gNodeB (gNB) to receive an access uplink in a slot in the candidate slots for UL reception on the access link, receive UL transmissions in the slot on the access link, and buffer the receive UL slot for later forwarding to the gNB, determine slots for a backhaul link and/or a control link UL transmissions, and receive an indication from the gNB to forward a buffered UL in the backhaul link and/or the control link UL slot. The NCR may also transmit a previously buffered access link UL slot from a UE.

### TECHNICAL FIELD

The present disclosure relates generally to communication systems. More specifically, the present disclosure relates to side information on TDD UL-DL configuration for Network Controlled Repeaters (NCR).

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a network controlled repeater (NCR) comprising: receiving circuitry configured to: receive a cell specific common time division duplex (TDD) uplink/downlink (UL/DL) configuration and a side information with an NCR dedicated TDD UL/DL configuration; determine candidate slots for uplink (UL) reception on an access link, wherein the access link is for communications between the NCR and associated UE(s); receive an indication from a gNodeB (gNB) to receive an access uplink in a slot in the candidate slots for UL reception on the access link; receive UL transmissions in the slot on the access link, and buffer the receive UL slot for later forwarding to the gNB; determine slots for a backhaul link and/or a control link UL transmissions, wherein the backhaul link and/or the control link are for communications between the NCR and the gNB; receive an indication from the gNB to forward a buffered UL in the backhaul link and/or the control link UL slot; and transmitting circuitry configured to: transmit a previous buffered access link UL slot from a UE in the backhaul link and/or the control link UL slot.

In one example, a gNodeB (gNB) comprising: transmitting circuitry configured to: transmit a cell specific common time division duplex (TDD) uplink/downlink (UL/DL) configuration and a side information with a network controlled repeater (NCR) dedicated TDD UL/DL configuration; determine candidate slots for uplink (UL) reception on an access link, wherein the access link is for communications between the NCR and associated UE(s); transmit an indication to the NCR to receive an access uplink in a slot in the candidate slots for UL reception on the access link; transmit UL transmissions in the slot on the access link; determine slots for a backhaul link and/or a control link UL transmissions, wherein the backhaul link and/or the control link are for communications between the NCR and the gNB; transmit an indication to the NCR to forward a buffered UL in the backhaul link and/or the control link UL slot; and receiving circuitry configured to: receive a previously buffered access link UL slot from a UE in the backhaul link and/or the control link UL slot.

In one example, a communication method of a network controlled repeater (NCR), comprising: receiving a cell specific common time division duplex (TDD) uplink/downlink (UL/DL) configuration and a side information with an NCR dedicated TDD UL/DL configuration; determining candidate slots for uplink (UL) reception on an access link, wherein the access link is for communications between the NCR and associated UE(s); receiving an indication from a gNodeB (gNB) to receive an access uplink in a slot in the candidate slots for UL reception on the access link; receiving UL transmissions in the slot on the access link, and buffer the receive UL slot for later forwarding to the gNB; determining slots for a backhaul link and/or a control link UL transmissions, wherein the backhaul link and/or the control link are for communications between the NCR and the gNB; receiving an indication from the gNB to forward a buffered UL in the backhaul link and/or the control link UL slot; and transmitting a previous buffered access link UL slot from a UE in the backhaul link and/or the control link UL slot.

### BRIEF DESCRIPTION OF DRAWINGS

FIG. 1 is a block diagram illustrating one implementation of one or more g Node Bs (gNBs) and one or more user equipment (UEs) in which systems and methods for signaling may be implemented.

FIG. 2 is an example of a block diagram of an NCR framework.

FIG. 3 is a diagram showing the parameters of TDD-UL-DL-ConfigCommon.

FIG. 4 is a diagram showing another example of the parameters of TDD-UL-DL-ConfigCommon.

FIG. 5 is a diagram showing an example of TDD-UL-DL-ConfigDedicated when only one pattern is configured.

FIG. 6 is a diagram showing examples of NCR TDD UL/DL configuration with dedicated configurations.

FIG. 7 is a diagram showing examples of NCR TDD UL/DL configuration with dedicated configurations when the partial slots with flexible symbols are included in the potential slots for NCR TDD UL/DL configuration.

FIG. 8 is a diagram showing some examples of NCR dedicated TDD UL/DL configurations when only a subset of slots in the potential slots are used.

FIG. 9 is a diagram showing another example of an NCR dedicated TDD UL/DL configuration in different regions.

FIG. 10 is a diagram showing another example of an NCR dedicated TDD UL/DL configuration when one region does not exist.

FIG. 11 is a diagram showing potential simultaneous transmission with beam management by an NCR.

FIG. 12 is a diagram showing some examples of NCR TDD UL/DL configurations with overlapping DL and/or UL slots.

FIG. 13 is a diagram showing examples of different regions with enhanced NCR access link TDD UL/DL configuration.

FIG. 14 is a diagram showing another example of an NCR TDD UL/DL configuration when one region does not exist.

FIG. 15 illustrates various components that may be utilized in a UE.

FIG. 16 illustrates various components that may be utilized in a gNB.

FIG. 17 illustrates various components that may be utilized in an NCR.

FIG. 18 is a block diagram illustrating one implementation of a UE in which one or more of the systems and/or methods described herein may be implemented.

FIG. 19 is a block diagram illustrating one implementation of a gNB in which one or more of the systems and/or methods described herein may be implemented.

FIG. 20 is a block diagram illustrating one implementation of an NCR in which one or more of the systems and/or methods described herein may be implemented.

FIG. 21 is a block diagram illustrating one implementation of a gNB.

FIG. 22 is a block diagram illustrating one implementation of a UE.

### DESCRIPTION OF EMBODIMENTS

A network controlled repeater (NCR) is described. The NCR may include receiving circuitry configured to receive a cell specific common time division duplex (TDD) uplink/downlink (UL/DL) configuration and a side information with an NCR dedicated TDD UL/DL configuration. The receiving circuitry may also be configured to determine candidate slots for uplink (UL) reception on an access link, wherein the access link is for communications between the NCR and associated UE(s). The receiving circuitry may also be configured to receive an indication from a gNodeB (gNB) to receive an access uplink in a slot in the candidate slots for UL reception on the access link, receive UL transmissions in the slot on the access link, and buffer the receive UL slot for later forwarding to the gNB. The receiving circuitry may also be configured to determine slots for a backhaul link and/or a control link UL transmissions, wherein the backhaul link and/or the control link are for communications between the NCR and the gNB, and receive an indication from the gNB to forward a buffered UL in the backhaul link and/or the control link UL slot. The NCR may also include transmitting circuitry configured to transmit a previous buffered access link UL slot from a UE in the backhaul link and/or the control link UL slot.

In some examples, the candidate slots for UL reception on the access link of the NCR may be determined by UL slots and flexible slots in the NCR dedicated TDD UL/DL configuration.

In certain aspects, the slots for backhaul link and/or the control link UL of the NCR may be limited to the UL and flexible slots in the cell specific common TDD UL/DL configuration that do not overlap with the NCR dedicated TDD UL/DL configuration and wherein the NCR is not expected to transmit an UL to the gNB in a slot within the NCR dedicated TDD UL/DL configuration. If an indication to forward an access UL in the backhaul link and/or the control link UL slot is received, the NCR may transmit a buffered UL from the access link to the gNB in the backhaul link and/or the control link UL, and if an UL transmission is scheduled from the gNB in the backhaul link and/or the control link UL slot, the NCR may transmit the scheduled UL to the gNB in the backhaul link and/or the control link UL.

In some examples, the slots for the backhaul link and/or the control link UL of the NCR may be determined by the UL slots and flexible slots in the cell specific common TDD UL/DL configuration only, and if an indication to forward an access UL in the backhaul link and/or the control link UL slot is received, the NCR may transmit a buffered UL from the access link to the gNB in the backhaul link and/or the control link UL. If an UL transmission is scheduled from the gNB in the backhaul link and/or the control link UL slot, the NCR may transmit the scheduled UL to the gNB in the backhaul link and/or the control link UL, and if the backhaul link and/or the control link UL slot is also a candidate slot for UL reception on the access link, and if an indication to receive an UL on the access link is received, the NCR may receive UL transmissions in the slot on the access link and buffers the received UL signal.

A gNodeB (gNB) is described. The gNB may include transmitting circuitry configured to transmit a cell specific common time division duplex (TDD) uplink/downlink (UL/DL) configuration and a side information with a network controlled repeater (NCR) dedicated TDD UL/DL configuration. The transmitting circuitry may also be configured to determine candidate slots for uplink (UL) reception on an access link, wherein the access link is for communications between the NCR and associated UE(s). The transmitting circuitry may also be configured to transmit an indication to the NCR to receive an access uplink in a slot in the candidate slots for UL reception on the access link, transmit UL transmissions in the slot on the access link, determine slots for a backhaul link and/or a control link UL transmissions, wherein the backhaul link and/or the control link are for communications between the NCR and the gNB, and transmit an indication to the NCR to forward a buffered UL in the backhaul link and/or the control link UL slot. The gNB may also include receiving circuitry configured to receive a previously buffered access link UL slot from a UE in the backhaul link and/or the control link UL slot.

A communication method of a network controlled repeater (NCR) is described. The communication method may include receiving a cell specific common time division duplex (TDD) uplink/downlink (UL/DL) configuration and a side information with an NCR dedicated TDD UL/DL configuration. The method may also include determining candidate slots for uplink (UL) reception on an access link, wherein the access link is for communications between the NCR and associated UE(s). The method may include receiving an indication from a gNodeB (gNB) to receive an access uplink in a slot in the candidate slots for UL reception on the access link, receiving UL transmissions in the slot on the access link, and buffer the receive UL slot for later forwarding to the gNB, determining slots for a backhaul link and/or a control link UL transmissions, wherein the backhaul link and/or the control link are for communications between the NCR and the gNB. The method may also include receiving an indication from the gNB to forward a buffered UL in the backhaul link and/or the control link UL slot, and transmitting a previous buffered access link UL slot from a UE in the backhaul link and/or the control link UL slot.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), LTE-Advanced Pro and other standards (e.g., 3GPP Releases 8, 9, 10, 11, 12, 13, 14, 15, 16, 17, and/or 18). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a g Node B (gNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Arca Network (LAN), the Internet, etc.) for wireless communication devices. The term “communication device” may be used to denote both a wireless communication device and/or a base station. An gNB may also be more generally referred to as a base station device.

It should be noted that as used herein, a “cell” may be any communication channel that is specified by standardization or regulatory bodies to be used for International Mobile Telecommunications-Advanced (IMT-Advanced) or IMT-2020, and all of it or a subset of it may be adopted by 3GPP as licensed bands or unlicensed bands (e.g., frequency bands) to be used for communication between an eNB or gNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and mMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink signal(s) and/or transmit an uplink signal(s) in the BWP(s) of the serving cell and/or the serving cell(s).

In order for the services to use the time, frequency, and/or spatial resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

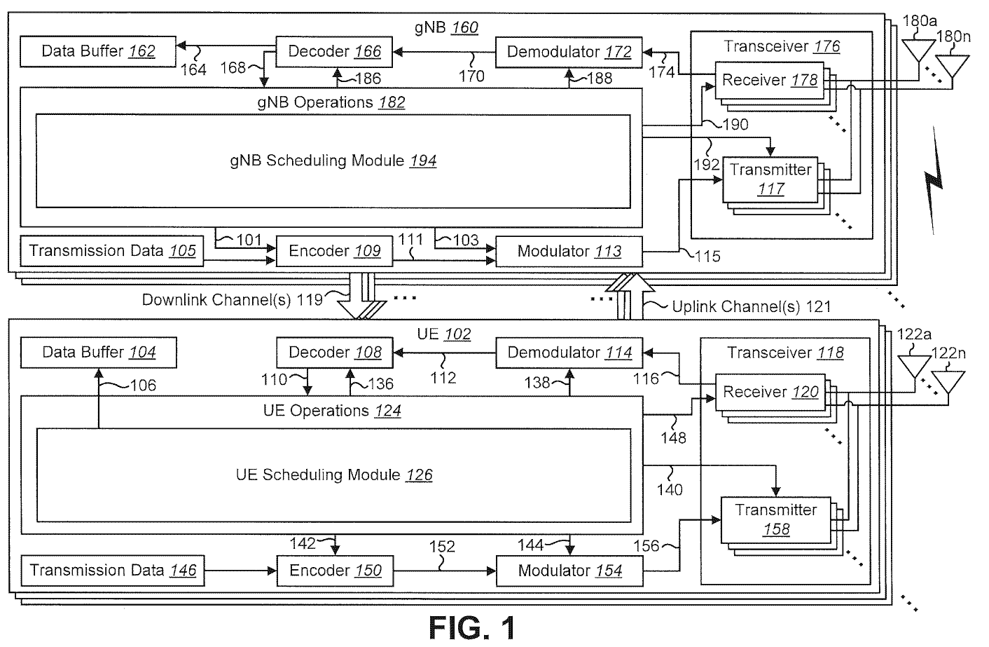

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDSCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

Also, in a carrier aggregation (CA), the gNB 160 and the UE 102 may communicate with each other using a set of serving cells. Here a set of serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate zero or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

Also, in a single cell operation, the gNB 160 and the UE 102 may communicate with each other using one serving cell. Here, the serving cell may be a primary cell.

In a radio communication system, physical channels (uplink physical channels and/or downlink physical channels) may be defined. The physical channels (uplink physical channels and/or downlink physical channels) may be used for transmitting information that is delivered from a higher layer and/or information that is generated from a physical layer.

### PRACH

For example, in uplink, a PRACH (Physical Random Access Channel) may be defined. In some approaches, the PRACH (e.g., as part of a random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

### PUCCH

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

### PDCCH

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

### PDSCH and PUSCH

A physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., ULSCH(s), an uplink transport block(s)).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

### SS/PBCH block

In some approaches, a physical broadcast channel (PBCH) may be defined. For example, the PBCH may be used for broadcasting the MIB (master information block). Here, system information may be divided into the MIB and a number of SIB(s) (system information block(s)). For example, the MIB may be used for carrying minimum system information. Additionally or alternatively, the SIB(s) may be used for carrying system information messages.

In some approaches, in downlink, synchronization signals (SSs) may be defined. The SS may be used for acquiring time and/or frequency synchronization with a cell. Additionally or alternatively, the SS may be used for detecting a physical layer cell ID of the cell. SSs may include a primary SS and a secondary SS.

An SS/PBCH block may be defined as a set of a primary SS (PSS), a secondary SS (SSS) and a PBCH. In the time domain, the SS/PBCH block consists of 4 OFDM symbols, numbered in terms of OFDM symbols in increasing order from 0 to 3 within the SS/PBCH block, where PSS, SSS, and PBCH with associated demodulation reference signal (DMRS) are mapped to symbols. One or more SS/PBCH blocks may be mapped within a certain time duration (e.g. 5 msec).

Additionally, the SS/PBCH block may be used for beam measurement, radio resource management (RRM) measurement and radio link monitoring (RLM) measurement. Specifically, the secondary synchronization signal (SSS) may be used for the measurement.

In the radio communication for uplink, UL RS(s) may be used as uplink physical signal(s). Additionally or alternatively, in the radio communication for downlink, DL RS(s) may be used as downlink physical signal(s). The uplink physical signal(s) and/or the downlink physical signal(s) may not be used to transmit information that is provided from the higher layer where the information is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

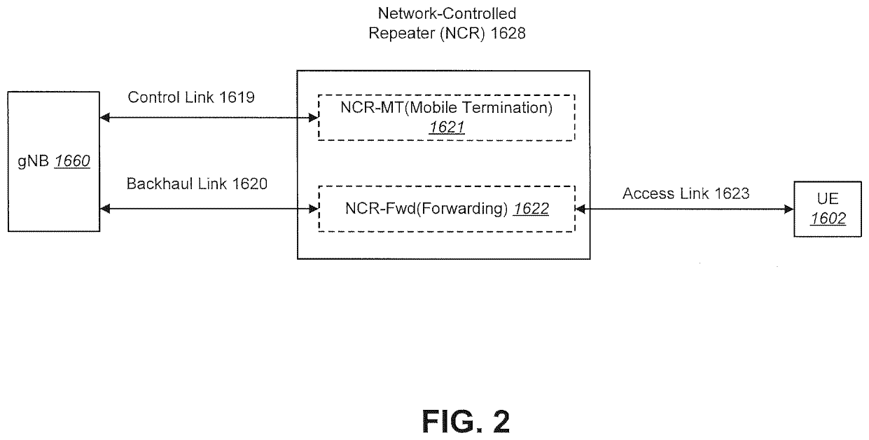

FIG. 2 is an example of a block diagram of an NCR 1628 framework. The NCR-MT 1621 (mobile termination) is defined as a function entity to communicate with a gNB 1660 via Control link 1619 (C-link) to enable the information exchanges (e.g. side control information). The C-link 1619 is based on NR UE interface. The side control information is at least for the control of NCR-Fwd 1622 (forwarding).

The NCR-Fwd 1622 is defined as a function entity to perform the amplify-and-forwarding of UL/DL RF signal between gNB 1660 and UE 1602 via backhaul link 1620 and access link 1623. The behavior of the NCR-Fwd 1622 will be controlled according to the received side control information from gNB 1660. The NCR-Fwd 1622 includes the backhaul link 1620 and the access link 1623.

The NCR 1628 can obtain the synchronization signals, e.g. SSBs and PBCH, MIB, and SIB, etc. on the NCR-MT 1621 and/or NCR-Fwd 1622. Furthermore, the NCR 1628 can receive the side information on NCR local configuration on control link 1619 with NCR-MT 1621.

The control link 1619 and the backhaul link 1620 at NCR 1628 can be performed simultaneously or in time division multiplexing (TDM). Specifically:

The DL of C-link 1619 and DL of backhaul link 1620 can be performed simultaneously (FDM) or in TDM way.

The UL of C-link 1619 and UL of backhaul link 1620 can be performed in TDM way.

Note that multiplexing is under the control of gNB 1660 with consideration for NCR capability

Also, simultaneous transmission of the UL of C-link 1619 and UL of backhaul link 1620 is subject to NCR's capability
a. Note: FDM may be supported, but resource collision may occur between forwarded traffic and C-link 1619.
b. If different subband regions are configured, then it is up to NCR capability.

A network controlled repeater (NCR), or a smart repeater can enhance the physical signaling forwarding with proper beams based on the locations of the gNB 1660 and the connected Ues (1602).

To perform the physical signal forwarding between the gNB 1660 and the UE 1602, the NCR 1628 needs to know the slot allocations by some side information.

A common TDD UL-DL configuration can be configured for a serving cell. A side information on NCR 1628 dedicated UL/DL configuration may be indicated by the gNB 1660 to NCR 1628.

The NCR 1628 can then determine based on the UL-DL configurations to determine the following.
which set of slots are used by the NCR 1628 to receive DL from gNB 1660,
which set of slots are used by the NCR 1628 to forward the DL from gNB 1660 to UE(s) 1602
which set of slots are used by the NCR 1628 to receive UL from UE(s) 1602.
which set of slots are used by the NCR 1628 to forward the UL from UE(s) 1602 to gNB 1660

Currently, it was agreed that the same TDD UL/DL configuration is assumed for the backhaul 1620 and access link 1623. But how to determine the usage of flexible slots are not decided yet.

Furthermore, the NCR behaviors with the UL/DL configurations are not specified yet, esp. how to determine the slots for access DL and access UL.

The cell specific TDD UL/DL configuration is known to both NCR 1628 and UEs. An additional NCR dedicated TDD UL/DL configuration can be configured for NCR 1628 further determine the access link DL and UL allocations.

Based on the TDD UL/DL configurations, the NCR 1628 can determine the slots can be used for each function, e.g. backhaul DL, access DL, access UL and backhaul UL.

The NCR behaviors in these slots are as follows:
Backhaul DL slots: the NCR 1628 receives the DL, if a slot is indicated by gNB 1660 to be forwarded on access link 1623, the NCR 1628 buffers the received DL signals.
Access DL slots: if a slot is indicated by gNB 1660 to transmit an access DL, the NCR 1628 transmits a previously buffered DL from gNB 1660 in the slot.
Access UL slots: if a slot is indicated by gNB 1660 to receive an access UL, the NCR 1628 receives a UL transmission on the access link 1623, and buffers the UL signal.
Backhaul UL slots: if a slot is indicated by gNB 1660 to forward signals from access link 1623, the NCR 1628 transmits a buffered UL signal to the gNB 1660 in the slot.

The detailed behaviors have some variations based on the restrictions on NCR dedicated TDD UL/DL configuration, e.g. the combinations of slot allocation in the common TDD UL/DL configuration and NCR dedicated UL/DL configuration.

For the TDD UL/DL configuration of network controller repeater (NCR 1628), at least semi-static TDD UL/DL configuration is needed for network-controlled repeater for links including C-link 1619, backhaul link 1620 and access link 1623. How to handle of flexible symbols should be studied further.

Note that the same TDD UL/DL configuration is always assumed for backhaul link 1620 and access link 1623. Also, the same TDD UL/DL configuration is assumed for C-link 1619 and backhaul link 1620 and access link 1623 if NCR-MT 1621 and NCR-Fwd 1622 are in the same frequency band.

The conventional UL/DL configuration if from gNB 1660 and UE's perspective. For relay type network, the DL and UL meaning may be different, e.g. in IAB and NCR.

In IAB, the IAB acts like a UE to gNB 1660, and follows the UL/DL configuration from the gNB 1660. Also, the IANB node configures the its own UL/DL configuration within the IAB network, and the UE 1602 only follows the IAB UL/DL configuration without knowledge of the doner gNB UL/DL configuration.

For NCR 1628, the IAB forwards the system information to UE 1602, thus, the UE and IAB have the same common UL/DL configuration. For the signaling of information on UL-DL TDD configuration, if the NCR-MT 1621 can acquire the TDD configuration as legacy UEs or from the OAM, new signaling may not be necessary. Note that the same TDD UL/DL configuration is assumed for C-link 1619 and backhaul link 1620 and access link 1623 if the NCR-MT 1621 and the NCR-Fwd 1622 are in the same frequency band.

However, to perform the physical signal forwarding between the gNB 1660 and the UE 1602, the NCR 1628 needs to know the slot UL/DL allocations by some side information with additional details, e.g.
which set of slots are used by the NCR 1628 to receive DL from gNB 1660,.
which set of slots are used by the NCR 1628 to forward the DL from gNB 1660 to UE(s) 1602.
which set of slots are used by the NCR 1628 to receive UL from UE(s) 1602.
which set of slots are used by the NCR 1628 to forward the UL from UE(s) to gNB 1660

The NCR behaviors in each set of slots can be specified accordingly with the tradeoff of complexity and flexibility.

In this disclosure, we propose several methods for UL/DL configuration for NCR 1628 to determine the different sets of slots for different transmission, reception and forwarding behaviors.

### Existing TDD UL/DL Configuration

NR provides a feature using which each symbol within a slot can either be used to schedule a Uplink packet (U) or Downlink packet (D) or Flexible (F). A symbol marked as Flexible means it can be used for either Uplink or Downlink as per requirement.

In NR, slot format configuration can be done in a static, semi-static or fully dynamic fashion. The configuration for Slot format would be broadcast from SIB1 or/and configured with the RRC Connection Reconfiguration message. The configuration of Static and semi-static for a slot is done using RRC while dynamic slot configuration is done using PDCCH DCI.

Note that if a slot configuration is not provided by the network through RRC messages, all the slots/symbols are considered as flexible by default.

Slot configuration via RRC consists of two parts.
Providing UE with Cell-Specific Slot format Configuration (TDD-UL-DL-ConfigCommon).
Providing UE with dedicated Slot format configuration (TDD-UL-DL-ConfigDedicated)

### TDD-UL-DL-ConfigCommon

The IE TDD-UL-DL-ConfigCommon is either broadcasted within SIB1 or configured to the UE using dedicated RRC signaling. When it is provided by RRC signaling then it is mandatory IE and when it is provided via SIB1, this IE is optional for TDD cells.

### TDD-UL-DL-ConfigCommon

The IE TDD-UL-DL-ConfigCommon determines the cell specific Uplink/Downlink TDD configuration.

TDD-UL-DL-ConfigCommon information element

-- ASN1START
-- TAG-TDD-UL-DL-CONFIGCOMMON-START

| | |
|---|---|
| TDD-UL-DL-ConfigCommon ::= | SEQUENCE { |
| referenceSubcarrierSpacing | SubcarrierSpacing, |
| pattern1 | TDD-UL-DL-Pattern, |
| pattern2 | TDD-UL-DL-Pattern |

OPTIONAL, -- Need R
...
}

| | |
|---|---|
| TDD-UL-DL-Pattern ::= | SEQUENCE { |
| dl-UL-TransmissionPeriodicity | ENUMERATED {ms0p5, ms0p625, ms1, ms1p25, ms2, |

ms2p5, ms5, ms10},

| | |
|---|---|
| nrofDownlinkSlots | INTEGER (0..maxNrofSlots), |
| nrofDownlinkSymbols | INTEGER (0..maxNrofSymbols−1), |
| nrofUplinkSlots | INTEGER (0..maxNrofSlots), |
| nrofUplinkSymbols | INTEGER (0..maxNrofSymbols−1), |

```
  ...,
  [[
```

| | |
|---|---|
| dl-UL-TransmissionPeriodicity-v1530 | ENUMERATED {ms3, ms4} |

OPTIONAL -- Need R
]]
}
-- TAG-TDD-UL-DL-CONFIGCOMMON-STOP
-- ASN1STOP

TDD-UL-DL-ConfigCommon field descriptions

referenceSubcarrierSpacing
Reference SCS used to determine the time domain boundaries in the UL-DL pattern which must be
common across all subcarrier specific carriers, i.e., independent of the actual subcarrier spacing using for
data transmission.
Only the following values are applicable depending on the used frequency:
FR1:
15, 30, or 60 kHz
FR2-1: 60 or 120 kHz
FR2-2: 120, 480, or 960 kHz
The network configures a not larger than any SCS of configured BWPs for the serving cell. The network or
SL-PreconfigGeneral configures a not larger than the SCS of (pre-)configured SL BWP. See TS 38.213 [13],
clause 11.1.

TDD-UL-DL-Pattern field descriptions

dl-UL-TransmissionPeriodicity
Periodicity of the DL-UL pattern, see TS 38.213 [13], clause 11.1. If the dl-UL-TransmissionPeriodicity-
v1530 is signalled, UE shall ignore the dl-UL-TransmissionPeriodicity (without suffix).
nrofDownlinkSlots
Number of consecutive full DL slots at the beginning of each DL-UL pattern, see TS 38.213 [13], clause
11.1. In this release, the maximum value for this field is 80.
nrofDownlinkSymbols
Number of consecutive DL symbols in the beginning of the slot following the last full DL slot (as derived
from nrofDownlinkSlots). The value 0 indicates that there is no partial-downlink slot. (see TS 38.213 [13],
clause 11.1).
nrofUplinkSlots
Number of consecutive full UL slots at the end of each DL-UL pattern, see TS 38.213 [13], clause 11.1. In
this release, the maximum value for this field is 80.
nrofUplinkSymbols
Number of consecutive UL symbols in the end of the slot preceding the first full UL slot (as derived from
nrofUplinkSlots). The value 0 indicates that there is no partial-uplink slot. (see TS 38.213 [13], clause 11.1).

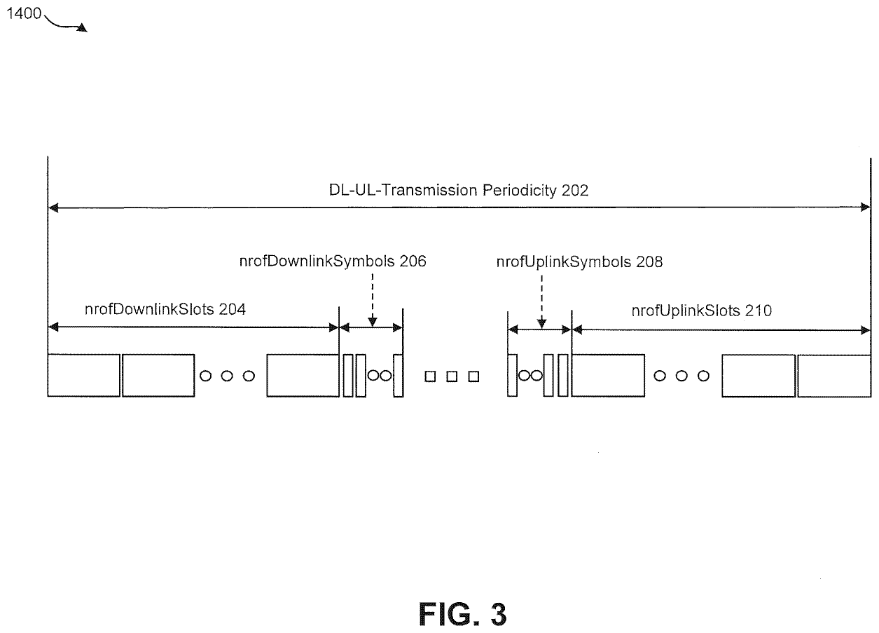

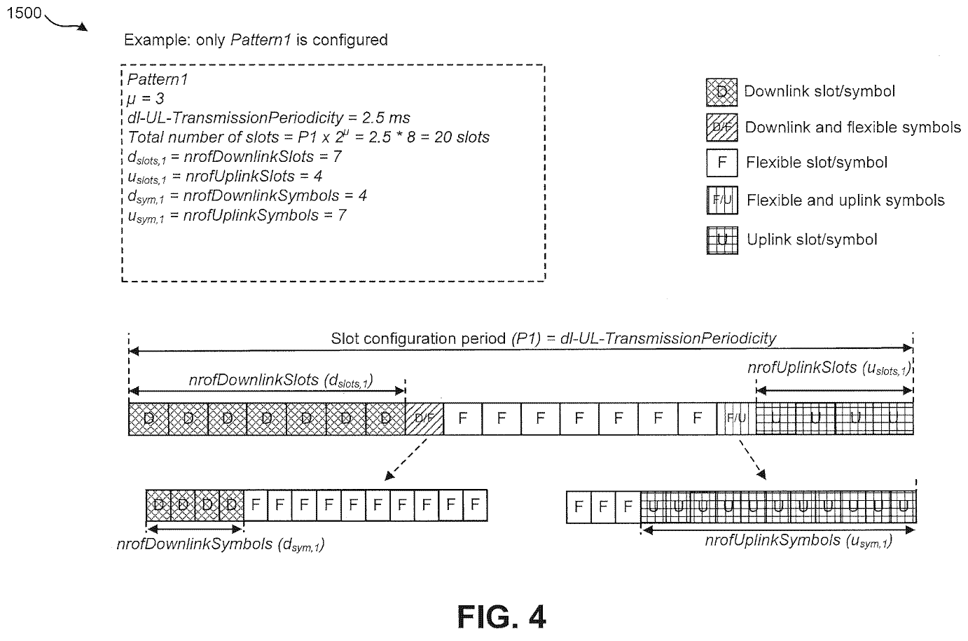

FIG. 3 is a diagram 1400 showing the parameters of TDD-UL-DL-ConfigCommon with an example 1500 illustrated in FIG. 4.

FIG. 4 is a diagram 1500 illustrating an example of an IE configuring the UE with at least one DL/UL pattern. pattern1 is mandatory and pattern2 is optional but by including pattern2, the network can have additional scheduling flexibility. Both pattern1 and pattern2 contain same parameters but usually of different values. The procedure for determining DL/UL pattern depends upon whether or not pattern2 is configured within TDD-UL-DL-ConfigCommon.

If only pattern1 is configured, a single DL/UL pattern is repeated periodically according to dl-UL-TransmissionPeriodicity 202. If both pattern1 and pattern2 are configured, two DL/UL patterns (pattern1 and pattern2) are placed next to each other. These two concatenated patterns jointly repeat with periodicity given by dl-UL-TransmissionPeriodicity (from pattern1)+dl-UL-TransmissionPeriodicity (from pattern2).

### TDD-UL-DL-ConfigDedicated

The RRC information TDD-UL-DL-ConfigDedicated is a UE specific information to the slot configuration. It is necessary to help the network adjust DL/UL pattern based on the UE needs.

The network sends the UE-specific slot configuration using IE TDD-UL-DL-ConfigDedicated towards UE which further allocates the unallocated (flexible) slots and symbols.

The IE TDD-UL-DL-ConfigDedicated is optional, and if the network doesn't configure this IE, the UE uses TDD-UL-DL-ConfigCommon IE alone to derive the slot configuration for transmission.

The configuration in TDD-UL-DL-ConfigDedicated IE can override only flexible symbols per slot over the number of slots as provided by TDD-UL-DL-ConfigCommon that is this dedicated configuration can not change the slots/symbols which are already allocated for downlink and uplink via TDD-UL-DL-ConfigCommon IE.

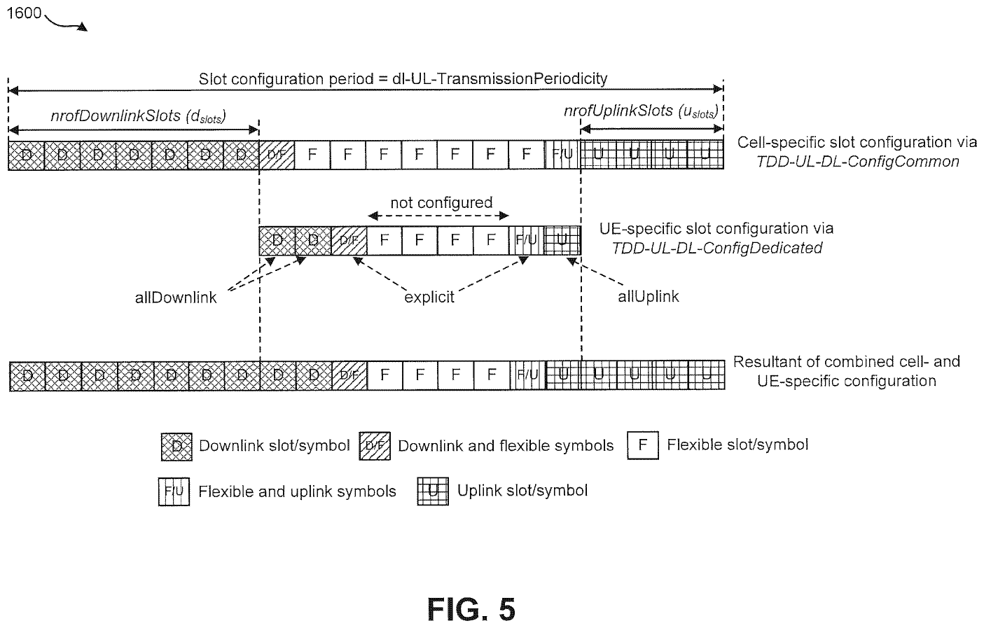

FIG. 5 shows an example 1600 of TDD-UL-DL-ConfigDedicated when only one pattern is configured.

In case two patterns are configured in TDD-UL-DL-ConfigCommon IE, a separate TDD-UL-DL-ConfigDedicated IE can be configured for each pattern to determine the allocation of flexible slots in each pattern.

The TDD-UL-DL-ConfigDedicated provides individual slot configuration(s) using slotSpecificConfigurations ToAddModList.

An IE TDD-UL-DL-ConfigDedicated-IAB-MT-r16 can be configured for IAB with similar parameters, and the format of each slot should be configured using slot specific configurations as well. The IAB can use the dedicated UL/DL configuration within the IAB coverage for UL/DL transmissions between the IAB and UE. If the IAB service link is on the same carrier as the backhaul link, the slot resources are divided by IAB and gNB. The IAB will only use the flexible slot defined by TDD-UL-DL-ConfigCommon by applying the TDD configuration indicated by TDD-UL-DL-ConfigDedicated.

### TDD-UL-DL-ConfigDedicated

The IE TDD-UL-DL-ConfigDedicated determines the UE-specific Uplink/Downlink TDD configuration.

TDD-UL-DL-ConfigDedicated information element

-- ASN1START
-- TAG-TDD-UL-DL-CONFIGDEDICATED-START

| | |
|---|---|
| TDD-UL-DL-ConfigDedicated ::= | SEQUENCE { |
| slotSpecificConfigurationsToAddModList | SEQUENCE (SIZE (1..maxNrofSlots)) OF TDD- |
| UL-DL-SlotConfig | OPTIONAL, -- Need N |
| slotSpecificConfigurationsToReleaseList | SEQUENCE (SIZE (1..maxNrofSlots)) OF TDD- |
| UL-DL-SlotIndex | OPTIONAL, -- Need N |

...
}

| | |
|---|---|
| TDD-UL-DL-ConfigDedicated-IAB-MT-r16::= | SEQUENCE { |

slotSpecificConfigurationsToAddModList-IAB-MT-r16 SEQUENCE (SIZE (1..maxNrofSlots))

| | |
|---|---|
| OF TDD-UL-DL-SlotConfig-IAB-MT-r16 | OPTIONAL, -- Need N |

slotSpecificConfigurationsToReleaseList-IAB-MT-r16 SEQUENCE (SIZE (1..maxNrofSlots))

| | |
|---|---|
| OF TDD-UL-DL-SlotIndex | OPTIONAL, -- Need N |

...
}

| | |
|---|---|
| TDD-UL-DL-SlotConfig ::= | SEQUENCE { |
| slotIndex | TDD-UL-DL-SlotIndex, |
| symbols | CHOICE { |
| allDownlink | NULL, |
| allUplink | NULL, |
| explicit | SEQUENCE { |
| nrofDownlinkSymbols | INTEGER (1..maxNrofSymbols−1) |

OPTIONAL, -- Need S

| | |
|---|---|
| nrofUplinkSymbols | INTEGER (1..maxNrofSymbols−1) |

```
OPTIONAL -- Need S
    }
  }
}
```

| | |
|---|---|
| TDD-UL-DL-SlotConfig-IAB-MT-r16::= | SEQUENCE { |
| slotIndex-r16 | TDD-UL-DL-SlotIndex, |
| symbols-IAB-MT-r16 | CHOICE { |
| allDownlink-r16 | NULL, |
| allUplink-r16 | NULL, |
| explicit-r16 | SEQUENCE { |
| nrofDownlinkSymbols-r16 | INTEGER (1..maxNrofSymbols−1) |

OPTIONAL, -- Need S

| | |
|---|---|
| nrofUplinkSymbols-r16 | INTEGER (1..maxNrofSymbols−1) |

OPTIONAL -- Need S
},

| | |
|---|---|
| explicit-IAB-MT-r16 | SEQUENCE { |
| nrofDownlinkSymbols-r16 | INTEGER (1..maxNrofSymbols−1) |

OPTIONAL, -- Need S

| | |
|---|---|
| nrofUplinkSymbols-r16 | INTEGER (1..maxNrofSymbols−1) |

```
OPTIONAL -- Need S
    }
  }
}
```

| | |
|---|---|
| TDD-UL-DL-SlotIndex ::= | INTEGER (0..maxNrofSlots−1) |

-- TAG-TDD-UL-DL-CONFIGDEDICATED-STOP
-- ASN1STOP

TDD-UL-DL-ConfigDedicated field descriptions

slotSpecificConfigurationsToAddModList
The slotSpecificConfigurationToAddModList allows overriding UL/DL allocations provided in TDD-UL-DL-
ConfigCommon, see TS 38.213 [13], clause 11.1.

TDD-UL-DL-ConfigDedicated-IAB-MT field descriptions

slotSpecificConfigurationsToAddModList-IAB-MT
The slotSpecificConfigurationToAddModList-IAB-MT allows overriding UL/DL allocations provided in TDD-
UL-DL-ConfigCommon with a limitation that effectively only flexible symbols can be overwritten in Rel-16.
slotSpecificConfigurationsToReleaseList-IAB-MT
The slotSpecificConfigurationsToReleaseList-IAB-MT allows release of a set of slot configuration
previously add with slotSpecificConfigurationToAddModList-IAB-MT.

TDD-UL-DL-SlotConfig field descriptions

nrofDownlinkSymbols
Number of consecutive DL symbols in the beginning of the slot identified by slotindex. If the field is absent
the UE assumes that there are no leading DL symbols. (see TS 38.213 [13], clause 11.1).
nrofUplinkSymbols
Number of consecutive UL symbols in the end of the slot identified by slotindex. If the field is absent the
UE assumes that there are no trailing UL symbols. (see TS 38.213 [13], clause 11.1).
slotIndex
Identifies a slot within a slot configuration period given in TDD-UL-DL-ConfigCommon, see TS 38.213 [13],
clause 11.1.
symbols
The direction (downlink or uplink) for the symbols in this slot. Value allDownlink indicates that all symbols
in this slot are used for downlink; value allUplink indicates that all symbols in this slot are used for uplink;
value explicit indicates explicitly how many symbols in the beginning and end of this slot are allocated to
downlink and uplink, respectively.

TDD-UL-DL-SlotConfig-IAB-MT field descriptions

symbols-IAB-MT
The symbols-IAB-MT is used to configure an IAB-MT with the SlotConfig applicable for one serving cell.
Value allDownlink indicates that all symbols in this slot are used for downlink; value allUplink indicates that
all symbols in this slot are used for uplink; value explicit indicates explicitly how many symbols in the
beginning and end of this slot are allocated to downlink and uplink, respectively; value explicit-IAB-MT
indicates explicitly how many symbols in the beginning and end of this slot are allocated to uplink and
downlink, respectively.

Dedicated TDD UL-DL configuration Methods for NCR with orthogonal slot resources for backhaul link and access link

With the NCR framework, the serving cell TDD UL/DL configurations by TDD-UL-DL-ConfigCommon can be reused. And the UE and NCR will receive the same TDD UL/DL configuration.

For a UE connected via an NCR to a gNB, the UE is out of coverage of the gNB, so it cannot receive and decode in fixed DL slots from gNB, and cannot transmit in a fixed UL slots to gNB directly either.

On the other hand, from NCR point of view, the access link and the backhaul link can only be used in TDM manner. Therefore, only the flexible slots may be fully utilized between the NCR and the UE.

With a given TDD UL/DL configuration, how to determine which slots are used for backhaul and which slots are used for access link should be specified. Especially, for a flexible slot, whether it is used for backhaul/control link or the access link, and how to divide the flexible slots for different operations.

As discussed above, only the flexible slots may be fully utilized between the NCR and the UE. Thus, the NCR can be configured with a dedicated TDD UL/DL configuration to determine the forward link slot allocations. And the NCR may assume the fixed DL and fixed UL slots are used only on the backhaul link and/or control link.

An IE TDD-UL-DL-ConfigDedicated-NCR-MT-r18 can be configured for NCR with similar parameters, and the format of each slot should be configured using slot specific configurations as well.

The NCR can use the dedicated UL/DL configuration within the NCR coverage for UL/DL transmissions between the NCR and UE. The TDD-UL-DL-ConfigDedicated-NCR-MT-r18 may also be known as TDD-UL-DL-ConfigDedicated-NCR-r18, or TDD-UL-DL-ConfigDedicated-NCR-Fwd-r18 etc.

### Approach 1: Reuse TDD-UL-DL-ConfigDedicated Structure

In one approach, the parameters in TDD-UL-DL-ConfigDedicated-NCR-MT-r18 are similar as TDD-UL-DL-ConfigDedicated, as given below.

| | |
|---|---|
| TDD-UL-DL-ConfigDedicated-NCR-MT-r18::= | SEQUENCE { |

slotSpecificConfigurationsToAddModList-NCR-MT-r18 SEQUENCE (SIZE (1..maxNrofSlots))

| | |
|---|---|
| OF TDD-UL-DL-SlotConfig-NCR-MT-r18 | OPTIONAL, -- Need N |

slotSpecificConfigurationsToReleaseList-NCR-MT-r18 SEQUENCE (SIZE (1..maxNrofSlots))

| | |
|---|---|
| OF TDD-UL-DL-SlotIndex | OPTIONAL, -- Need N |

...
}

| | |
|---|---|
| TDD-UL-DL-SlotConfig-NCR-MT-r18::= | SEQUENCE { |
| slotIndex-r18 | TDD-UL-DL-SlotIndex, |
| symbols-NCR-MT-r18 | CHOICE { |
| allDownlink-r18 | NULL, |
| allUplink-r18 | NULL, |
| explicit-r18 | SEQUENCE { |
| nrofDownlinkSymbols-r18 | INTEGER (1..maxNrofSymbols−1) |

OPTIONAL, -- Need S

| | |
|---|---|
| nrofUplinkSymbols-r18 | INTEGER (1..maxNrofSymbols−1) |

OPTIONAL -- Need S
},

| | |
|---|---|
| explicit-NCR-MT-r18 | SEQUENCE { |
| nrofDownlinkSymbols-r18 | INTEGER (1..maxNrofSymbols−1) |

OPTIONAL, -- Need S

| | |
|---|---|
| nrofUplinkSymbols-r18 | INTEGER (1..maxNrofSymbols−1) |

```
OPTIONAL -- Need S
    }
  }
}
```

TDD-UL-DL-ConfigDedicated-NCR-MT field descriptions

slotSpecificConfigurationsToAddModList-NCR-MT
The slotSpecificConfigurationToAddModList-NCR-MT allows overriding UL/DL allocations provided in
TDD-UL-DL-ConfigCommon with a limitation that effectively only flexible symbols can be overwritten in
Rel-17.
slotSpecificConfigurationsToReleaseList-NCR-MT
The slotSpecificConfigurationsToReleaseList-NCR-MT allows release of a set of slot configuration
previously add with slotSpecificConfigurationToAddModList-NCR-MT.

TDD-UL-DL-SlotConfig-NCR-MT field descriptions

symbols-NCR-MT
The symbols-NCR-MT is used to configure an IAB-MT with the SlotConfig applicable for one serving cell.
Value allDownlink indicates that all symbols in this slot are used for downlink; value allUplink indicates that
all symbols in this slot are used for uplink; value explicit indicates explicitly how many symbols in the
beginning and end of this slot are allocated to downlink and uplink, respectively; value explicit-NCR-MT
indicates explicitly how many symbols in the beginning and end of this slot are allocated to uplink and
downlink, respectively.

This is similar as IAB. However, IAB has its own scheduler, it decodes all packets from/to gNB, encodes the packet again and reschedules transmissions to/from UE. Thus, the slot allocation can be very flexible for IAB as in the current dedicated TDD UL/DL configuration. Furthermore, the IAB controls the DL and UL transmissions in the allocation slot region.

In TDD-UL-DL-ConfigDedicated, any slot with flexible symbols can be configured. Thus, the potential slots in a TDD-UL-DL-ConfigDedicated IE includes the partial DL slot and the partial UL slot as well.

In one method, since the partial DL slot may be used for DL transmission, and the partial UL slot may be scheduled for UL transmission to the gNB, the NCR potential slots in a TDD-UL-DL-ConfigDedicated-NCR-MT should not include the partial slots with flexible symbols. That is a clear difference from the existing TDD-UL-DL-ConfigDedicated.

In another method, the NCR potential slots in a TDD-UL-DL-ConfigDedicated-NCR-MT may include the partial slots with flexible symbols. In this case, the partial slots with flexible symbols can be treated as a flexible symbol. And a slot with partial flexible symbols may be used by either the backhaul/control link or the access link.
If a partial DL slot is indicated as a slot for access link, the gNB should not transmit in a partial DL slot.
Similarly, if a partial DL slot is indicated as a slot for access link, the gNB should not schedule transmissions from associated UEs in a partial UL slot.

In both methods, the NCR may be configured with all potential slots or only a subset of the potential slots. A slot index and a detailed configuration of the slot can be configured for each slot in the potential slot for NCR TDD UL/DL configuration. This provides maximum flexibility for the slot configuration among the flexible slots. And the DL slots and UL slots are not necessarily configured in continuous slots.

### Approach 2: Define TDD-UL-DL-ConfigDedicated-NCR Structure as in TDD-UL-DL-ConfigCommon Pattern

However, an NCR can only do physical signal forwarding, and cannot decode the packets between the gNB and UE. The slot structure of a slot on the access link for data forwarding should be the same as the slot structure of a forwarded slot on the backhaul link. Thus, the flexible format of each slot with the IE structure in TDD-UL-DL-ConfigDedicated is not only more complicated, but also invalid if the forwarding slot has a different slot format from the forwarded slot.

Therefore, in another approach, the TDD-UL-DL-ConfigDedicated-NCR IE may use parameters similar as the TDD-UL-DL-ConfigCommon instead.

In one method, since the partial DL slot may be used for DL transmission, and the partial UL slot may be scheduled for UL transmission to the gNB, the NCR potential slots in a TDD-UL-DL-ConfigDedicated-NCR-MT should not include the partial slots with flexible symbols. That is a clear difference from the existing TDD-UL-DL-ConfigDedicated.

In another method, the NCR potential slots in a TDD-UL-DL-ConfigDedicated-NCR-MT may include the partial slots with flexible symbols. In this case, the partial slots with flexible symbols can be treated as a flexible symbol. And a slot with partial flexible symbols may be used by either the backhaul/control link or the access link.

Furthermore, besides the methods of potential slot determination, two difference cases can be considered depending on whether all potential slots are configured in the dedicated NCR TDD UL/DL configuration.

### Case 1: All Potential Slots are Configured in the NCR Dedicated TDD UL/DL Configuration

In one case, all potential slots are allocated in the TDD UL/DL configuration for NCR. This maximize the available slots that can be used by the NCR on the access link.

With the parameters in TDD-UL-DL-ConfigCommon, the NCR can obtain the potential slots based on the number of flexible slots and the location of the flexible slots. Basically, the NCR can determine it based on the TDD pattern periodicity (dl-UL-TransmissionPeriodicity), the number of DL slots (nrofDownlinkSlots), and the number of UL slots (nrofUplinkSlots).

Thus, if all potential slots are allocated in the TDD UL/DL configuration for NCR, there is no need to include the TDD pattern duration, the TDD UL/DL configuration for NCR (TDD-UL-DL-ConfigDedicated-NCR) only needs to define the number of DL slots and the number of UL slots in the duration of the potential slots.

A sample IE structure is shown below. The TDD-UL-DL-ConfigDedicated-NCR can also be known as TDD-UL-DL-Config-Pattern-NCR, TDD-UL-DL-Pattern-NCR, etc.

TDD-UL-DL-ConfigDedicated-NCR information element

| | |
|---|---|
| TDD-UL-DL-Config-Pattern-NCR ::= | SEQUENCE { |
| nrofDownlinkSlots | INTEGER (0..maxNrofSlots), |
| nrofDownlinkSymbols | INTEGER (0..maxNrofSymbols−1), |
| nrofUplinkSlots | INTEGER (0..maxNrofSlots), |
| nrofUplinkSymbols | INTEGER (0..maxNrofSymbols−1), |

}

TDD-UL-DL-Config-Pattern-NCR field descriptions

nrofDownlinkSlots
Number of consecutive full DL slots at the beginning of each DL-UL pattern, see TS 38.213 [13], clause
11.1. In this release, the maximum value for this field is 80.
nrofDownlinkSymbols
Number of consecutive DL symbols in the beginning of the slot following the last full DL slot (as derived
from nrofDownlinkSlots). The value 0 indicates that there is no partial-downlink slot. (see TS 38.213 [13],
clause 11.1).
nrofUplinkSlots
Number of consecutive full UL slots at the end of each DL-UL pattern, see TS 38.213 [13], clause 11.1. In
this release, the maximum value for this field is 80.
nrofUplinkSymbols
Number of consecutive UL symbols in the end of the slot preceding the first full UL slot (as derived from
nrofUplinkSlots). The value 0 indicates that there is no partial-uplink slot. (see TS 38.213 [13], clause 11.1).

The total number of DL slots and the number of UL slots should be smaller than the number of flexible slots. For more flexibility, there may be flexible slots left in the middle.

Furthermore, if there are flexible symbols in the middle, the nrofDownlinkSymbols in the IE should be the same as the nrofDownlinkSymbols in the TDD-UL-DL-ConfigCommon. And the nrofUplinkSymbols in the IE should be the same as the nrofUplinkSymbols in the TDD-UL-DL-ConfigCommon. This ensures that if the partial slot is used for data forward by the NCR, the same slot format is maintained.

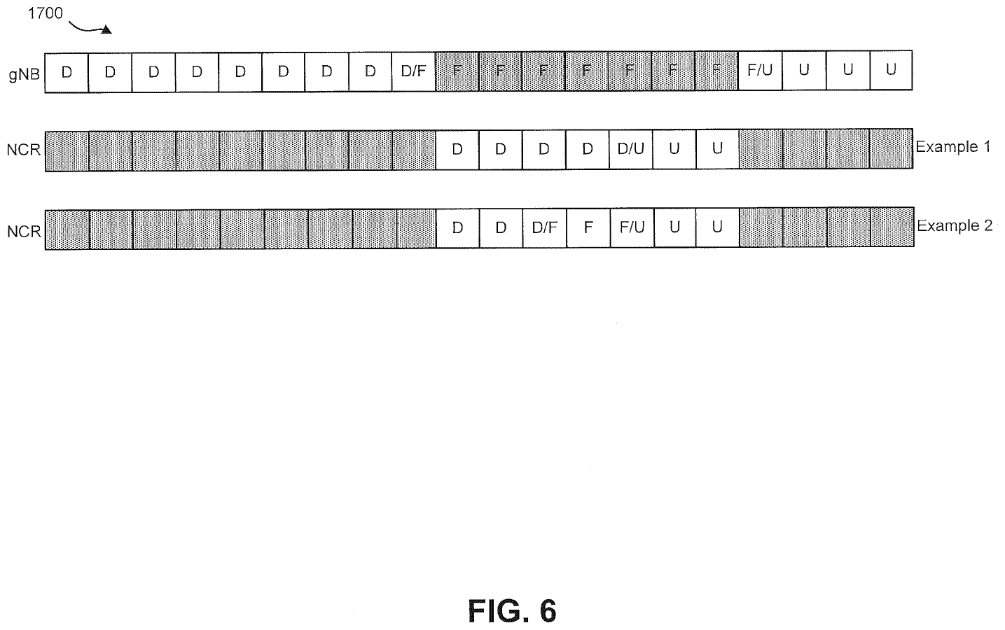

FIG. 6 shows some examples 1700 of NCR TDD UL/DL configuration with dedicated configurations. In FIG. 6, the partial slots with flexible symbols are not included in the potential slots for NCR TDD UL/DL configuration.

The DL, UL and flexible slots are configured by the TDD-UL-DL-ConfigCommon. The NCR dedicated TDD UL/DL configuration configures the DL and UL allocation within the flexible symbols. In FIG. 6 NCR example 1, all flexible slots are allocated as DL and/or UL. In FIG. 6 example 2, some flexible symbols are left for better scheduling flexibility.

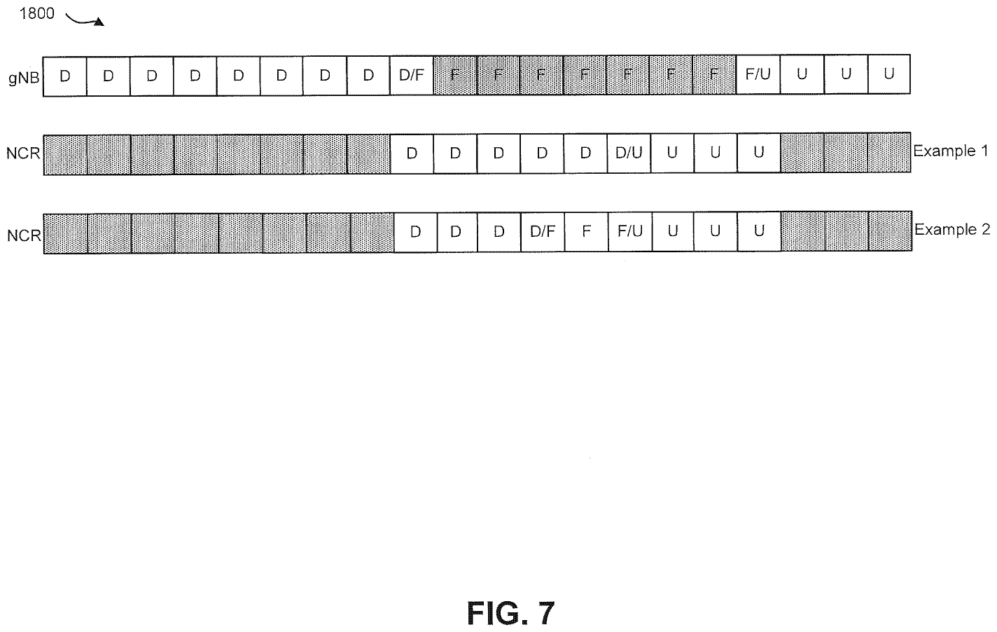

FIG. 7 shows some examples 1800 of NCR TDD UL/DL configuration with dedicated configurations when the partial slots with flexible symbols are included in the potential slots for NCR TDD UL/DL configuration. For the partial DL, if an NCR is indicated to transmit a forwarded DL on access link, the gNB is not expected to transmit in the partial DL. Similarly, for the partial UL slot, if an NCR is indicated to receive an UL on the access link, the gNB is not expected to schedule other UL transmissions in the partial UL.

### Case 2: a Subset of Continuous Slots Within the Potential Slots are Configured in the NCR Dedicated TDD UL/DL Configuration

In another case, the NCR dedicated TDD UL/DL configuration may not use all the flexible slots. Instead, only a subset of continuous slots within the potential slots are configured in the NCR dedicated TDD UL/DL configuration.

In this case, the NCR dedicated TDD UL/DL configuration needs to define TDD UL/DL configuration with more parameters beyond the existing TDD-UL-DL-ConfigCommon. For example, with a periodic pattern duration of dl-UL-TransmissionPeriodicity, the starting slot index and the number of slots should be additionally indicated in the new IE. The starting slot and the ending slot should be within the potential NCR slots. Alternatively, the starting slot index and ending slot index can be used to derive the number of slots for the NCR specific TDD UL/DL configuration.

TDD-UL-DL-ConfigDedicated-NCR information element

| | |
|---|---|
| TDD-UL-DL-Config-Pattern-NCR ::= | SEQUENCE { |
| startingSlotIndex | INTEGER (0..dl-UL-TransmissionPeriodicity−1), |
| nrofSlots | INTEGER (0..dl-UL-TransmissionPeriodicity), |
| nrofDownlinkSlots | INTEGER (0..maxNrofSlots), |
| nrofDownlinkSymbols | INTEGER (0..maxNrofSymbols−1), |
| nrofUplinkSlots | INTEGER (0..maxNrofSlots), |
| nrofUplinkSymbols | INTEGER (0..maxNrofSymbols−1), |

}

The startingSlotIndex indicates the starting slot index number within the periodicity given by dl-UL-TransmissionPeriodicity in TDD-UL-DL-ConfigCommon. If the dl-UL-TransmissionPeriodicity-v1530 is signalled, UE shall ignore the dl-UL-TransmissionPeriodicity (without suffix). The nrofSlots indicates the duration of the TDD UL/DL configuration in a number of slots from the starting slot index within the potential slots for NCR.

Furthermore, if flexible symbols are included in the NCR dedicated UL/DL configuration, the nrofDownlinkSymbols in the IE should be the same as the nrofDown-linkSymbols in the TDD-UL-DL-ConfigCommon. And the nrofUplinkSymbols in the IE should be the same as the nrofUplinkSymbols in the TDD-UL-DL-ConfigCommon. This ensures that if the partial slot is used for data forward by the NCR, the same slot format is maintained.

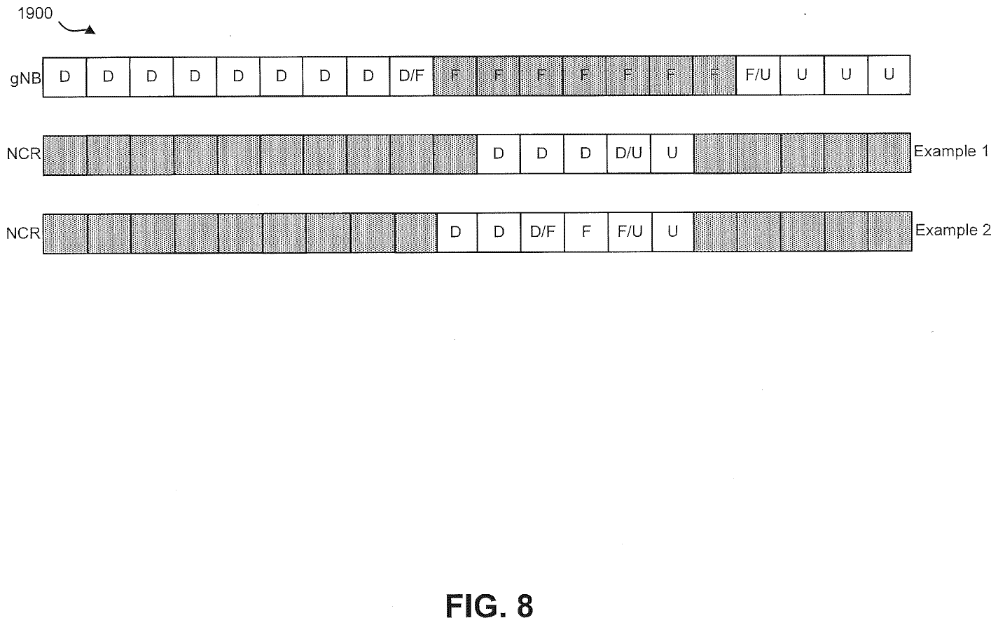

FIG. 8 shows some examples 1900 of NCR dedicated TDD UL/DL configurations when only a subset of slots in the potential slots are used. The DL, UL and flexible slots are determined by the TDD-UL-DL-ConfigCommon. The NCR dedicated TDD UL/DL configuration configures the DL and UL allocation in a sunset of the flexible symbols.

In another approach, since the slots are within the set of full flexible slots which is determined by the TDD-UL-DL-ConfigCommon already. The startingSlotIndex may indicate the starting slot index number in relative to the first full flexible slot within the set of full flexible slots in the TDD-UL-DL-ConfigCommon.

### NCR Behavior With NCR Dedicated TDD UL/DL Configuration

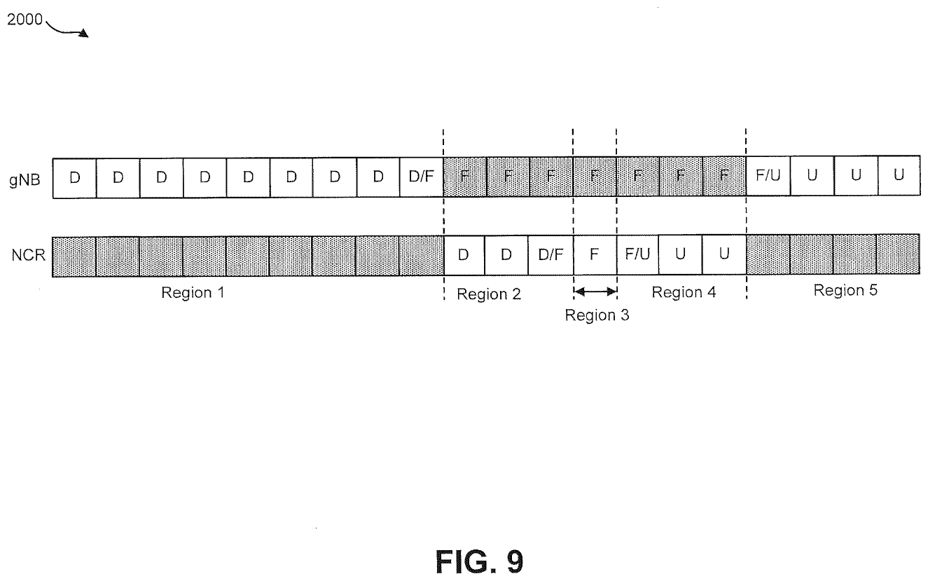

FIG. 9 shows an example 2000 illustrating the TDD UL/DL configurations common and dedicated NCR configurations, the access link UL/DL allocation can be determined in different regions based on the overlapping conditions.

### Region 1: The Fixed DL Slots in the TDD-UL-DL-ConfigCommon

The fixed DL slots in the TDD-UL-DL-ConfigCommon are used only as backhaul link and/or control link DL to receive DL signals from gNB.
The NCR should always monitor the fixed DL from gNB.
The DL may include side information to the NCR and/or physical layer signals to be forwarded to UE(s) linked to the NCR.
If a slot is indicated by gNB to be forwarded by the NCR, the NCR should buffer the DL slot and forward it in a later slot following gNB indication.

### Region 2: Flexible Slots in the TDD-UL-DL-ConfigCommon and DL Slots and DL Allocations in the NCR Dedicated TDD UL/DL Configuration

The DL slots and DL allocations in the TDD-UL-DL-ConfigDedicated-NCR-MT are used as access link DL to forward DL signals from gNB to UE.
The NCR may transit a forwarded DL slot only if it is indicated/signaled by the gNB.

### Region 3: Flexible Slots in Both the TDD-UL-DL-ConfigCommon and the NCR Dedicated TDD UL/DL Configuration

Region 3 contains flexible slots in both the TDD-UL-DL-ConfigCommon and the NCR dedicated TDD UL/DL configuration. Region 3 may also include flexible slots in the TDD-UL-DL-ConfigCommon that are not included in the NCR dedicated UL/DL configuration when only a subset of continuous slots within the potential slots are configured in the NCR dedicated TDD UL/DL configuration.

If there are flexible slot(s) in the TDD-UL-DL-ConfigDedicated-NCR-MT, the flexible slot can be used as access link DL or UL based on gNB indication and/or signaling.
The NCR may transit a forwarded DL slot only if it is indicated/signaled by the gNB. In this case, the slot is used as an access link DL.
The NCR may listen to an UL slot from UE(s) only if it is indicated/signaled by the gNB. In this case, the slot is used as an access link UL.

### Region 4: Flexible Slots in the TDD-UL-DL-ConfigCommon and UL Slots and UL Allocations in the NCR Dedicated TDD UL/DL Configuration

The UL slots and UL allocations in the TDD-UL-DL-ConfigDedicated-NCR-MT are used as access link UL to receive UL signals from UE.
The NCR may listen to an UL slot only if it is indicated/signaled by the gNB.

### Region 5: The Fixed UL Slots in the TDD-UL-DL-ConfigCommon

The fixed UL slots in the TDD-UL-DL-ConfigCommon are used only as backhaul link and/or control link UL to transmit UL signals to the gNB.
The UL signal may be a forwarded UL signal from UE(s), or an NCR UL channel directly to the gNB.
The NCR should only forward a UL signal from a UE in an UL slot if it is indicated/signaled by the gNB.

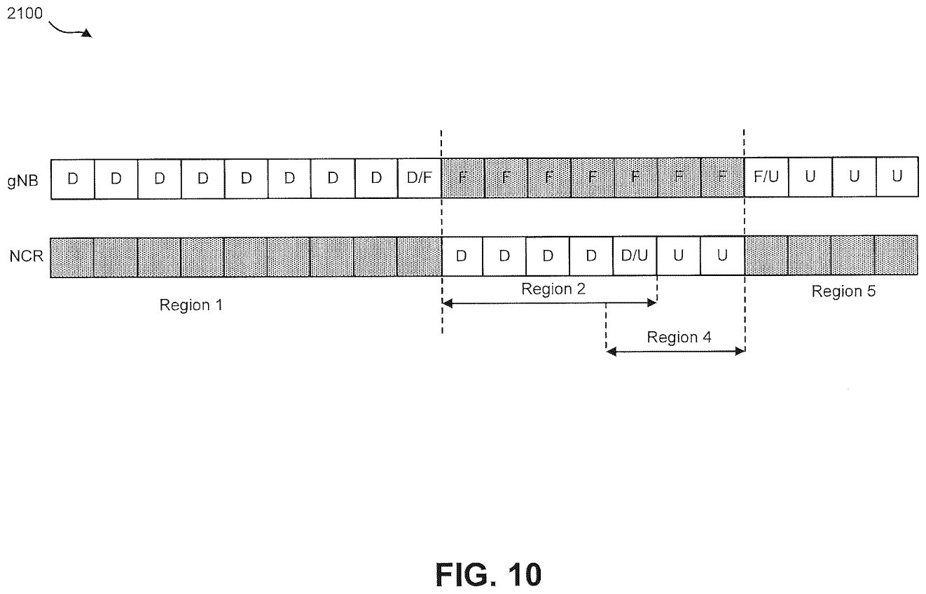

FIG. 10 illustrates an example 2100 where, if region 3 does not exist, the transitional slots with D/U allocation may be included in both region 2 and region 4.

Note that the TDD UL/DL dedicated configuration may be only known at NCR. The UE may assume all slots in the middle are flexible slots. Alternatively and/or additionally, the gNB may configure the same configuration in TDD-UL-DL-ConfigDedicated to UEs under the NCR, so that the UEs and NCR can share the same TDD UL/DL configurations.

With the dedicated TDD UL/DL configuration, the NCR behavior above is a desired tradeoff between NCR complexity and gNB flexibility, thus

For the access link defined by the NCR dedicated TDD UL/DL configuration. Only the flexible slots in TDD-UL-DL-ConfigCommon can be used as the access link.
The NCR only transmits on the access link in a DL or flexible slot of the NCR dedicated TDD UL/DL configuration if it is signaled by the gNB.
The NCR only receives on the access link in a UL or flexible slot of the NCR dedicated TDD UL/DL configuration if it is signaled by the gNB.

In one approach, for the slots configured in the NCR dedicated TDD UL/DL configuration,
the NCR is not required or not expected to monitor the DL from gNB, and,
the NCR is not expected to be scheduled with an UL transmission either.

Thus, for the backhaul link and/or control link
In one case, only the fixed DL and fixed UL in TDD-UL-DL-ConfigCommon can be used as backhaul link and/or control link. Thus, the NCR only monitors fixed DL slots for backhaul and/or control link transmission, and can only transmit to gNB in fixed UL slots.
In another case, if the NCR dedicated TDD UL/DL configuration occupies a subset of flexible slots, the flexible slots outside of the NCR dedicated TDD UL/DL configuration can also be used as backhaul link and/or control link.

In another approach, for maximum scheduling flexibility, the backhaul link and/or control link follows the TDD-UL-DL-ConfigCommon, and the access link follows the NCR specific TDD UL/DL configuration.
The gNB may use all fixed DL and flexible slots in TDD-UL-DL-ConfigCommon for backhaul link DL and/or control link DL.
The gNB may use all fixed UL and flexible slots in TDD-UL-DL-ConfigCommon for backhaul link UL and/or control link UL.
For the slots configured by the NCR dedicated TDD UL/DL configuration, if a slot is not indicated/signaled by the gNB as a forwarding DL slot to UE(s) or a reception UL slot from UE(s) on the access link, the NCR may still monitor it for DL transmissions from gNB or may perform UL transmissions to gNB if scheduled.

Note that the gNB may still use the flexible slots for DL and/or UL transmissions to other UEs connected directly to the gNB. However, if a flexible slot is indicated as an access DL or access UL, the gNB should not transmit DL slot or schedule UL trans-missions in the same slot for the UEs directly associated to the gNB.

### Enhancement of NCR Access Link Transmission With Beam Considerations

In the previous section, the dedicated TDD UL/DL configuration for NCR can only use the flexible slots in the TDD-UL-DL-ConfigCommon. This assumes the slots for the access link and backhaul link are divided and cannot be used for the other link. Due to this restriction, the method has many limitations, e.g.
The NCR does not have much slot resource to use if the TDD-UL-DI-ConfigCommon has a small number of flexible symbols.
The UE monitors all DL and flexible slots, but will only receive data in the flexible slots. The monitoring and reception in fixed DL slots are wasted.
The NCR assumes that gNB will not use flexible slots. This causes waste of slots resources if the NCR traffic is low.

On the other hand, if the gNB is able to schedule NCR transmissions in fixed DL or fixed UL slots, it will be more flexible for gNB scheduling, and can potentially reduce the forwarding delay at the NCR.

NCR transmission in a fixed DL slot may cause interference to other UEs under the same gNB. With beam management, the interference can be alleviated or eliminated. Beam management is an important feature for NR, especially for FR2. The gNB beams and NCR beams are managed separately based on the UEs' locations.

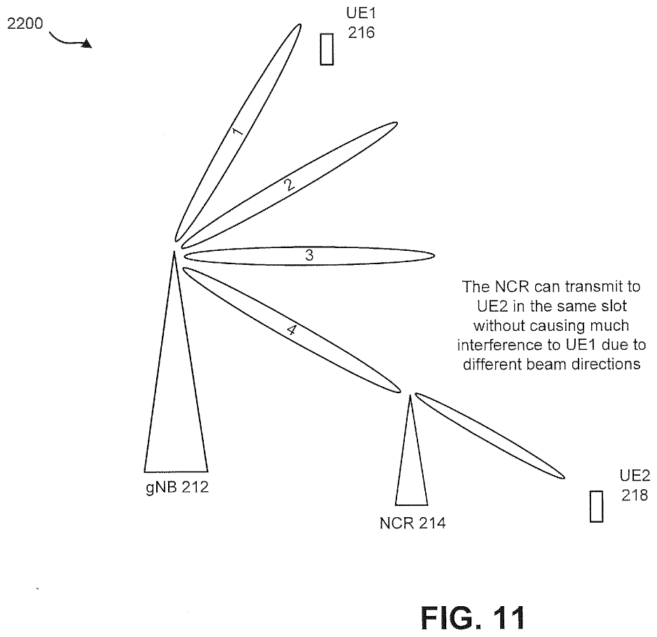

In one scenario 2200, as shown in FIG. 11, the gNB 212 may transmit to UE1 216 using beam 1 in a DL slot. If the NCR 214 transmits to UE2 218 using a beam pointing to a different direction in the same slot, it will not cause much interference to UE1 216. Thus, it is possible to allow simultaneous gNB 212 and NCR DL transmissions using spatially separated beams in the same slot. Similarly, since UE2 218 is out of range of the gNB 212, the UE1 216 and UE2 218 may transmit UL signals in the same slot without causing much interference to each other.

In another scenario, if the interference is a problem and cannot be avoided, the gNB 212 may choose not to transmit in a DL slot, and may indicate the NCR 214 to transmit in the given DL slot instead.

Therefore, it may be beneficial for the gNB 212 to have more scheduling flexibility and allowing some slots shared by the gNB 212 and NCR transmissions even if a slot can only be used by the gNB 212 or NCR 214 at any given time. Additionally, the gNB 212 can also use a flexible slot if the flexible slot is not scheduled for NCR transmission on the access link.

### Enhanced TDD UL/DL Configuration for NCR Access Link

To support this, new TDD UL/DL configuration for NCR 214 is required. The new TDD UL/DL configuration may be applied on the access link for communications between the NCR 214 and the UE.

The enhance TDD UL/DL configuration for NCR 214 may allow some overlapping DLs and/or overlapping ULs between gNB 212 and NCR TDD UL/DL configurations.

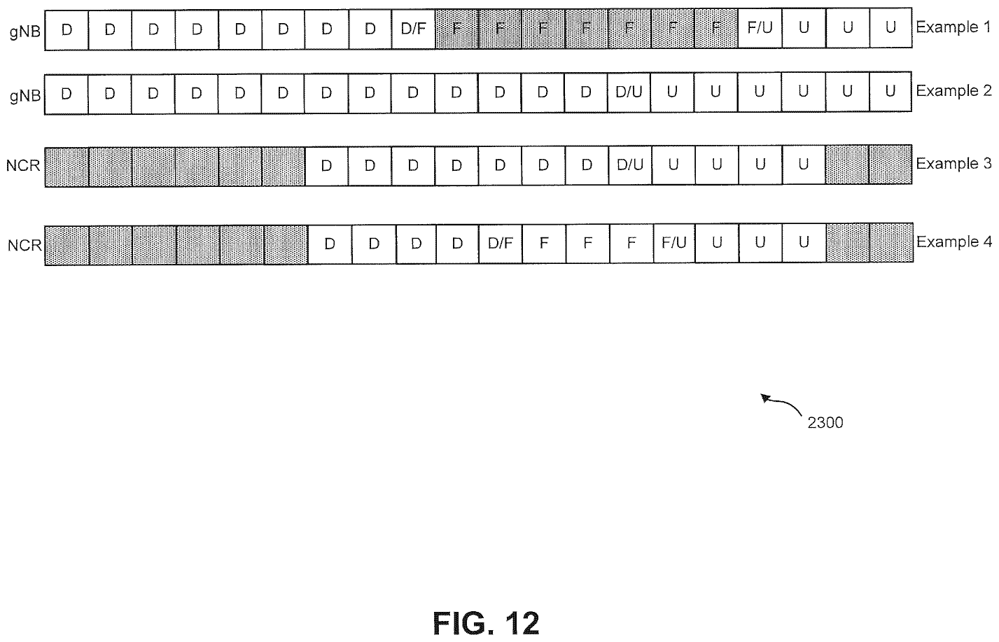

FIG. 12 shows some examples 2300 with enhanced NCR TDD UL/DL configurations that allow some overlapping DL slot(s) and/or overlapping UL slot(s) between the gNB and NCR TDD UL/DL configurations. Thus, the NCR can be scheduled with more flexibility for data forwarding with potential simultaneous transmission by beam management.

In FIG. 12, gNB example 1, there are some flexible slots configured. In FIG. 12, NCR example 3, more slots are allocated for the NCR than the number of flexible slots, and all slots are assigned with a direction. In FIG. 12, NCR example 4, several flexible slots are configured within the NCR TDD configuration.

In FIG. 12, gNB example 2, all slots are allocated as DL and/or UL. Even if there is no flexible slots, the NCR can still be configured as in NCR example 3 and 4. This shows clear enhancement over the previous method which only allocates NCR resources within the flexible slots.

The new TDD UL/DL configuration for access link needs to define TDD UL/DL configuration with more parameters beyond the existing TDD-UL-DL-ConfigCommon and TDD-UL-DL-ConfigDedicated.

For example, with a periodic pattern duration of dl-UL-TransmissionPeriodicity, the starting slot index and the number of slots should be additionally indicated by the new IE. Alternatively, the starting slot index and ending slot index can be used to derive the number of slots for the NCR specific TDD UL/DL configuration.

### Approach 1: Define a TDD Dedicated UL/DL Configuration Allowing Slot Indexes Outside of Flexible Slots

In one approach, the TDD-UL-DL-ConfigDedicated IE structure may be reused to define the NCR access link UL/DL allocation, as given above in TDD-UL-DL-ConfigDedicated-NCR-MT-r18.

Since the slot index is included in the IE, and the slot format of each slot can be configured independently, this approach provides best flexibility on the UL/DL configuration. In the existing TDD-UL-DL-ConfigDedicated, only the flexible slots can be configured with slot index and slot format.

In the enhanced TDD UL/DL configuration for NCR access link, TDD-UL-DL-ConfigDedicated-NCR-MT-r18, the slot index is not limited to flexible slots, e.g. it can point to a fixed DL slot or a fixed UL slot as well.

However, the flexibility of the TDD-UL-DL-ConfigDedicated IE may be unnecessary, and sometimes problematic for NCR operations. Since an NCR can only do physical signal forwarding, it does not decode the packets between the gNB and UE. The slot structure of a slot on the access link for data forwarding should be the same as the slot structure of a forwarded slot on the backhaul link. Thus, the flexible format of each slot configured using slot specific configurations are not only more complicated, but also invalid if the slot structure is different from the forwarded slot.

### Approach 2: Define a TDD Pattern With Starting Slot Index and a Number of Slots

Therefore, in another approach, the TDD-UL-DL-Config-NCR IE may use parameters similar as the TDD-UL-DL-ConfigCommon.

Since the periodicity of the pattern is already given by the dl-UL-TransmissionPeriodicity in the TDD-UL-DL-ConfigCommon, the periodicity does not need to be included again in the NCR TDD UL/DL configuration.

Within a periodic pattern duration, the starting slot index and the number of slots should be additionally indicated by the new IE for NCR TDD ULDL configuration. Alternatively, the starting slot index and ending slot index can be used to derive the number of slots for the NCR specific TDD UL/DL configuration.

Additionally, the number of DL slots and the number of UL slots in the given set of slots should be configured.

TDD-UL-DL-Config-NCR can also be known as TDD-UL-DL-ConfigDedicated-NCR, TDD-UL-DL-Config-Pattern-NCR, or TDD-UL-DL-Pattern-NCR, etc.

TDD-UL-DL-Config-NCR information element

| | |
|---|---|
| TDD-UL-DL-Config-NCR ::= | SEQUENCE { |
| startingSlotIndex | INTEGER (0..dl-UL-TransmissionPeriodicity−1), |
| nrofSlots | INTEGER (0..dl-UL-TransmissionPeriodicity), |
| nrofDownlinkSlots | INTEGER (0..maxNrofSlots), |
| nrofDownlinkSymbols | INTEGER (0..maxNrofSymbols−1), |
| nrofUplinkSlots | INTEGER (0..maxNrofSlots), |
| nrofUplinkSymbols | INTEGER (0..maxNrofSymbols−1), |

}

The startingSlotIndex indicates the starting slot index number within the periodicity given by dl-UL-TransmissionPeriodicity in TDD-UL-DL-ConfigCommon. If the dl-UL-TransmissionPeriodicity-v1530 is signalled, UE shall ignore the dl-UL-TransmissionPeriodicity (without suffix). The nrofSlots indicates the duration of the TDD UL/DL configuration in a number of slots from the starting slot index within the periodicity.

Furthermore, the nrofDownlinkSymbols in the IE should be the same as the nrof-DownlinkSymbols in the TDD-UL-DL-ConfigCommon. And the nrofUplinkSymbols in the IE should be the same as the nrofUplinkSymbols in the TDD-UL-DL-ConfigCommon. This ensures that if the partial slot is used for data forward by the NCR, the same slot format is maintained.

The slot range of the new configuration defines the access link configuration. The access link slots may have some overlapping with the serving cell TDD UL/DL configuration provided by the TDD-UL-DL-ConfigCommon. However, the access link configuration can be transparent to UEs connected to the NCR.

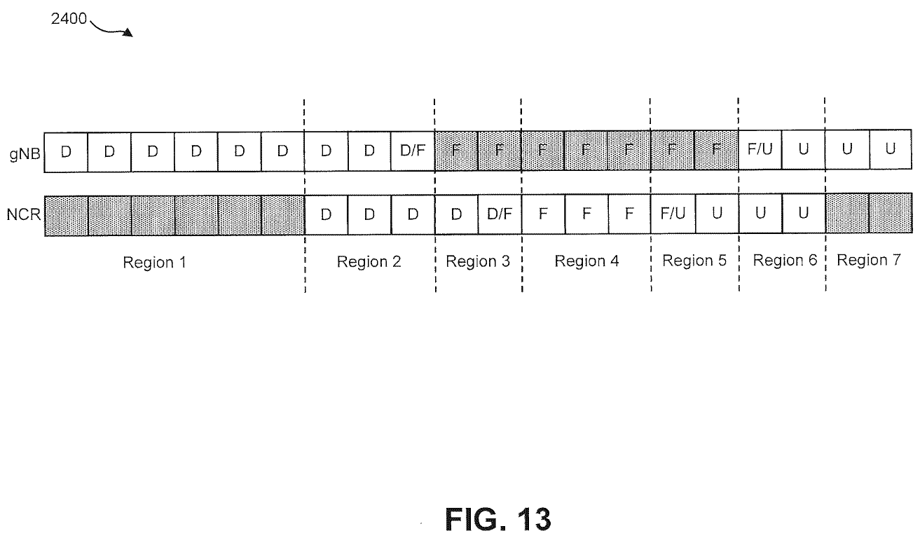

NCR behavior with enhanced NCR access link TDD UL/DL configuration With the enhanced TDD UL/DL configuration for the access link, there may be some overlapping between the serving cell common TDD UL/DL configuration and the NCR TDD UL/DL configuration. The NCR behavior can be defined accordingly in different regions based on the overlapping conditions, as shown in FIG. 13.

FIG. 13 shows examples 2400 of different regions with enhanced NCR access link TDD UL/DL configuration

### Region 1: The Fixed DL Slots in the TDD-UL-DL-ConfigCommon Only, and the Slots are not Included in the NCR Access Link TDD UL/DL Configuration

The fixed DL slots in region 1 are used only as backhaul link and/or control link DL to receive DL signals from gNB.
The NCR should always monitor the fixed DL from gNB.
The DL may include side information to the NCR and/or physical layer signals to be forwarded to UE(s) linked to the NCR.
If a slot is indicated by gNB to be forwarded by the NCR, the NCR should buffer the DL slot and forward it in a later slot following gNB indication.

### Region 2: Overlapping DL Slots in the TDD-UL-DL-ConfigCommon and the NCR Access Link TDD UL/DL Configuration

The DL slots in region 2 may be used as a regular DL or an access link DL to forward DL signals from gNB to UE.
If a slot is indicated/signaled by the gNB as an access link DL, the NCR should transit a forwarded DL slot in the slot based on the gNB indication/signaling.
If a slot is indicated by gNB to be forwarded by the NCR, the NCR should buffer the DL slot and forward it in a later slot following gNB indication.
Otherwise, the NCR should monitor it as a regular DL.

### Region 3: Flexible Slots in the TDD-UL-DL-ConfigCommon and DL Slots/Allocations in the NCR Access Link TDD UL/DL Configuration

The slots in region 3 may be used as access link DL to forward DL signals from gNB to UE.
The NCR may transit a forwarded DL slot only if it is indicated/signaled by the gNB.

### Region 4: Flexible Slots in Both the TDD-UL-DL-ConfigCommon and the NCR Access Link TDD UL/DL Configuration

If there are flexible slot(s) in the NCR access link TDD UL/DL configuration, the flexible slot can be used as access link DL or UL based on gNB indication and/or signaling.
The NCR may transit a forwarded DL slot only if it is indicated/signaled by the gNB. In this case, the slot is used as an access link DL.
The NCR may listen to an UL slot from UE(s) only if it is indicated/signaled by the gNB. In this case, the slot is used as an access link UL.

### Region 5: Flexible Slots in the TDD-UL-DL-ConfigCommon and UL Slots and UL Allocations in the NCR Access Link TDD UL/DL Configuration

The UL slots and UL allocations in the NCR access link TDD UL/DL configuration are used as access link UL to receive UL signals from UE.
The NCR may listen to an UL slot only if it is indicated/signaled by the gNB.

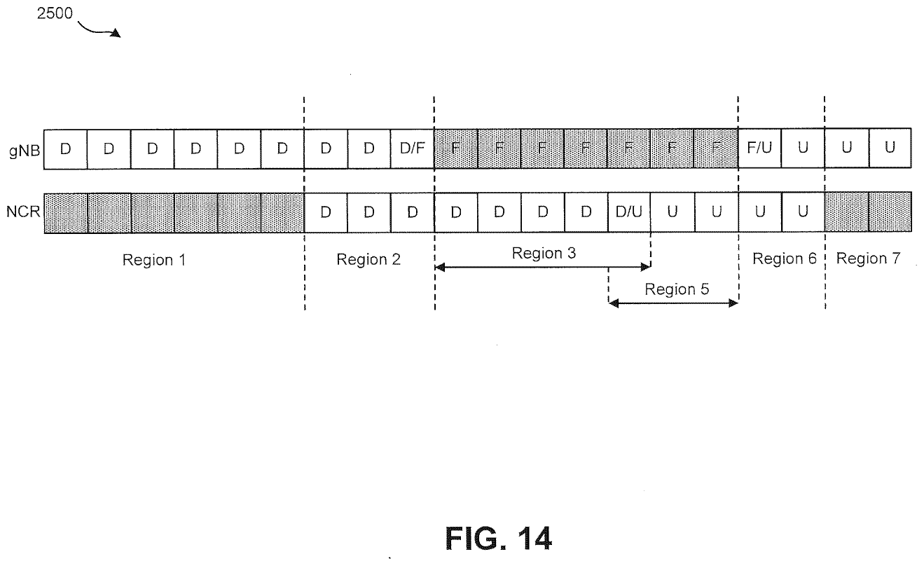

As shown in an example 2500 illustrated in FIG. 14, if region 4 does not exist, all slots in the NCR TDD UL/DL configuration is configured as DL and/or UL. In this example, the transitional slot with D/U allocation may be included in both region 3 and region 5.

Alternatively, the transitional slot with D/U allocation may be included in region 3 only if the slots is a DL heavy slot, and be included in region 5 only if the slots is a UL heavy slot.

### Region 6: Overlapping UL Slots in the TDD-UL-DL-ConfigCommon and the NCR Access Link TDD UL/DL Configuration

The UL slots in region 6 may be used as a regular UL or an access link UL to receive UL signals from UE(s).
If a slot is indicated/signaled by the gNB as an access link UL, the NCR should receive the UL transmission(s) from UE(s) in the slot.
If a UL transmission is scheduled by the gNB for the NCR, the NCR should transmit a UL to the gNB.

### Region 7: The Fixed UL Slots in the TDD-UL-DL-ConfigCommon Only, and the Slots are not Included in the NCR Access Link TDD UL/DL Configuration

The fixed UL slots in region 7 are used only as backhaul link and/or control link UL to transmit UL signals to the gNB.
The UL signal may be a forwarded UL signal from UE(s), or an NCR UL channel directly to the gNB.
The NCR should only forward a UL signal from a UE in a fixed UL slot when it is indicated/signaled by the gNB.

Note that the TDD UL/DL dedicated configuration may be only known at NCR. The UE may assume all slots in the middle are flexible slots.

For the access link defined by the NCR dedicated TDD UL/DL configuration
There may be some overlapping DL or UL slots with TDD-UL-DL-ConfigCommon on the access link.
The NCR only transmits on the access link in a DL or flexible slot of the NCR dedicated TDD UL/DL configuration if it is signaled by the gNB.
The NCR only receives on the access link in a UL or flexible slot of the NCR dedicated TDD UL/DL configuration if it is signaled by the gNB.

In one approach, for the slots configured in the NCR dedicated TDD UL/DL configuration,
the NCR is not required or not expected to monitor the DL from gNB in a slot even if the slot is a DL or flexible slot in the TDD-UL-DL-ConfigCommon, and.
the NCR is not expected to be scheduled with an UL transmission even if the slot is a UL or flexible slot in the TDD-UL-DL-ConfigCommon.

Thus, for the backhaul link and/or control link, only the fixed DL and fixed UL in TDD-UL-DL-ConfigCommon and outside the range of the NCR dedicated TDD UL/DL configuration can be used as backhaul link and/or control link. Thus,.
the NCR only monitors fixed DL slots in TDD-UL-DL-ConfigCommon and outside the range of the NCR dedicated TDD UL/DL configuration for backhaul and/or control link transmission, and
the NCR can only transmit to gNB in fixed UL slots in TDD-UL-DL-ConfigCommon and outside the range of the NCR dedicated TDD UL/DL configuration.

In another approach, for the slots configured in the NCR dedicated TDD UL/DL configuration,
the NCR is not required or not expected to monitor the DL from gNB in a slot if the slot is a flexible slot in the TDD-UL-DL-ConfigCommon, and.
the NCR is not expected to be scheduled with an UL transmission if the slot is a flexible slot in the TDD-UL-DL-ConfigCommon.

Accordingly, for the backhaul link and/or control link, all the fixed DL and fixed UL in TDD-UL-DL-ConfigCommon can be used as backhaul link and/or control link.

Yet in another approach, for maximum scheduling flexibility, the backhaul link and/or control link follows the TDD-UL-DL-ConfigCommon, and the access link follows the NCR specific TDD UI/DL, configuration.
The gNB may use all fixed DL and flexible slots in TDD-UL-DL-ConfigCommon for backhaul link DL and/or control link DL.
The gNB may use all fixed UL and flexible slots in TDD-UL-DL-ConfigCommon for backhaul link UI, and/or control link UL.
For the slots configured by the NCR dedicated TDD UL/DL configuration, if a slot is not indicated/signaled by the gNB as a forwarding DL slot to UE(s) or a reception UL slot from UE(s) on the access link, the NCR may still monitor it for DL transmissions from gNB or may perform UL transmissions to gNB if scheduled.

Note that the gNB may still use the flexible slots for DL and/or UL transmissions to other UEs connected directly to the gNB. However, if a flexible slot is indicated as an access DL or access UL, the gNB should not transmit DL slot or schedule UL transmissions in the same slot for the UEs directly associated to the gNB.

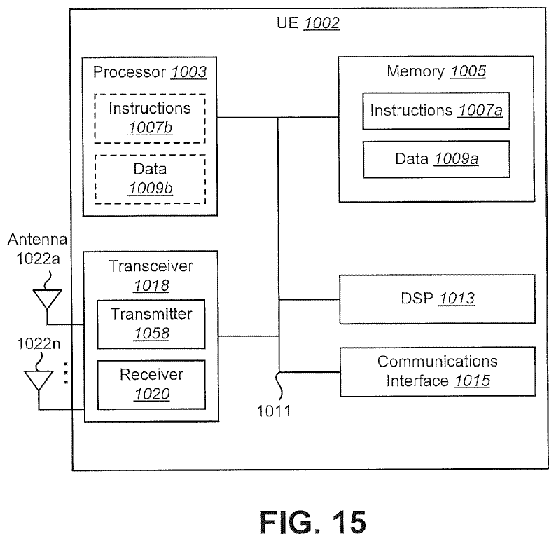

FIG. 15 illustrates various components that may be utilized in a UE 1002. The UE 1002 described in connection with FIG. 15 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described herein.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 15 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 15 is a functional block diagram rather than a listing of specific components.

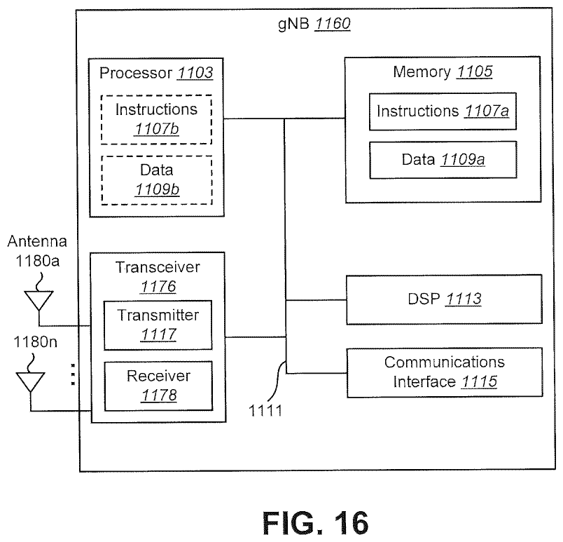

FIG. 16 illustrates various components that may be utilized in a gNB 1160. The gNB 1160 described in connection with FIG. 16 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include non-volatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described herein.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 16 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 16 is a functional block diagram rather than a listing of specific components.

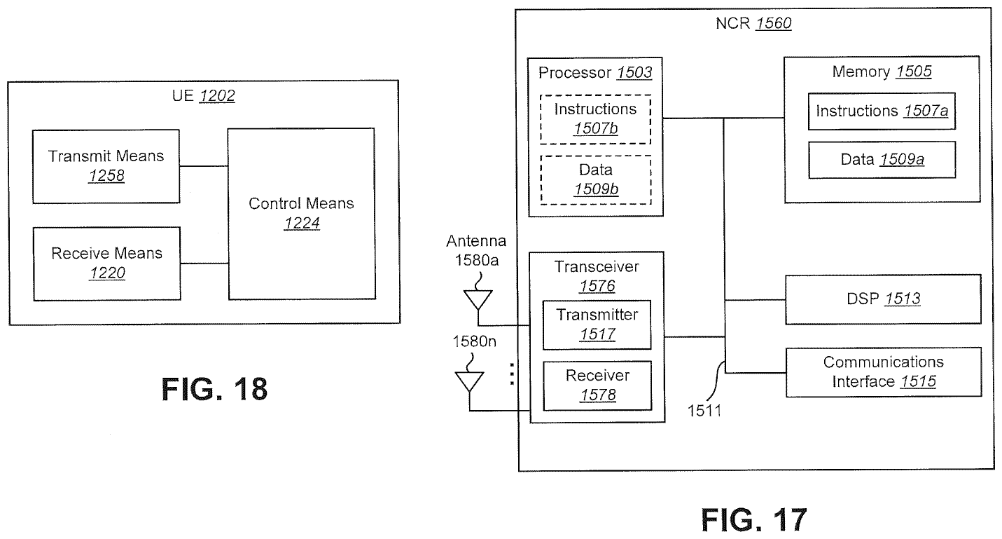

FIG. 17 illustrates various components that may be utilized in an NCR 1560. The NCR 1560 described in connection with FIG. 17 may be implemented in accordance with the NCR described herein. The NCR 1560 includes a processor 1503 that controls operation of the NCR 1560. The processor 1503 may also be referred to as a central processing unit (CPU). Memory 1505, which may include read-only memory (ROM), random access memory (RAM), a combination of the two or any type of device that may store information, provides instructions 1507a and data 1509a to the processor 1503. A portion of the memory 1505 may also include non-volatile random access memory (NVRAM). Instructions 1507b and data 1509b may also reside in the processor 1503. Instructions 1507b and/or data 1509b loaded into the processor 1503 may also include instructions 1507a and/or data 1509a from memory 1505 that were loaded for execution or processing by the processor 1503. The instructions 1507b may be executed by the processor 1503 to implement the methods described herein.

The NCR 1560 may also include a housing that contains one or more transmitters 1517 and one or more receivers 1578 to allow transmission and reception of data. The transmitter(s) 1517 and receiver(s) 1578 may be combined into one or more transceivers 1576. One or more antennas 1580a-n are attached to the housing and electrically coupled to the transceiver 1576.

The various components of the NCR 1560 are coupled together by a bus system 1511, which may include a power bus, a control signal bus and a status signal bus, in addition to a data bus. However, for the sake of clarity, the various buses are illustrated in FIG. 17 as the bus system 1511. The NCR 1560 may also include a digital signal processor (DSP) 1513 for use in processing signals. The NCR 1560 may also include a communications interface 1515 that provides user access to the functions of the NCR 1560. The NCR 1560 illustrated in FIG. 17 is a functional block diagram rather than a listing of specific components.

FIG. 18 is a block diagram illustrating one implementation of a UE 1202 in which one or more of the systems and/or methods described herein may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 15 above illustrates one example of a concrete apparatus structure of FIG. 18. Other various structures may be implemented to realize one or more of the functions of FIG. 1. For example, a DSP may be realized by software.

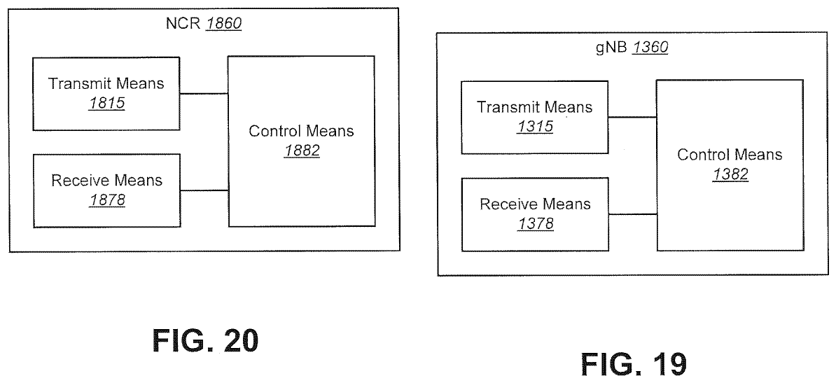

FIG. 19 is a block diagram illustrating one implementation of a gNB 1360 in which one or more of the systems and/or methods described herein may be implemented. The gNB 1360 includes transmit means 1315, receive means 1378 and control means 1382. The transmit means 1315, receive means 1378 and control means 1382 may be configured to perform one or more of the functions described in connection with FIG. 1 above. FIG. 16 above illustrates one example of a concrete apparatus structure of FIG. 19. Other various structures may be implemented to realize one or more of the functions of FIG. 1. For example, a DSP may be realized by software.

FIG. 20 is a block diagram illustrating one implementation of an NCR 1860 in which one or more of the systems and/or methods described herein may be implemented. The NCR 1860 includes transmit means 1815, receive means 1878 and control means 1882. The transmit means 1815, receive means 1878 and control means 1882 may be configured to perform one or more of the functions described herein. FIG. 17 above illustrates one example of a concrete apparatus structure of FIG. 20. Other various structures may be implemented to realize one or more of the functions of FIG. 1. For example, a DSP may be realized by software.

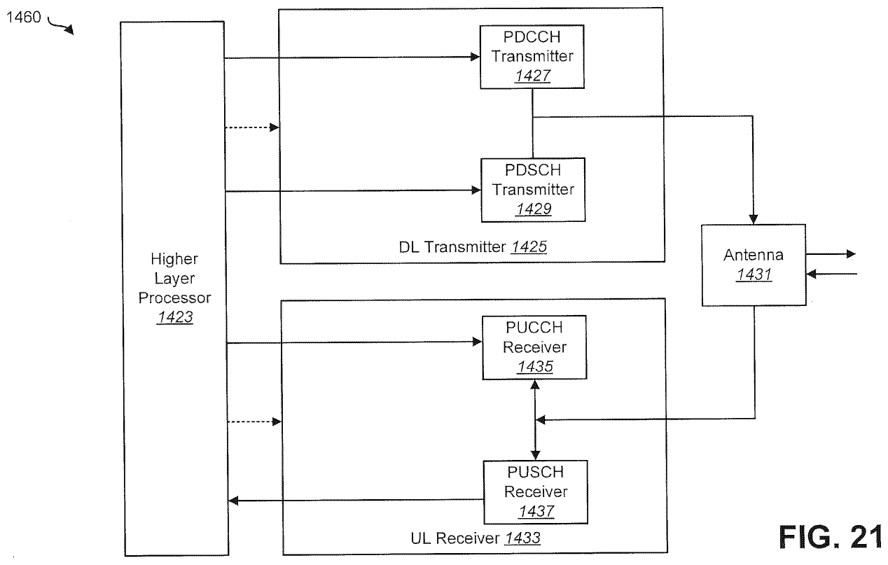

FIG. 21 is a block diagram illustrating one implementation of a gNB 1460. The gNB 1460 may be an example of the gNB 160 described in connection with FIG. 1. The gNB 1460 may include a higher layer processor 1423, a DL transmitter 1425, a UL receiver 1433, and one or more antenna 1431. The DL transmitter 1425 may include a PDCCH transmitter 1427 and a PDSCH transmitter 1429. The UL receiver 1433 may include a PUCCH receiver 1435 and a PUSCH receiver 1437.

The higher layer processor 1423 may manage physical layer's behaviors (the DL transmitter's and the UL receiver's behaviors) and provide higher layer parameters to the physical layer. The higher layer processor 1423 may obtain transport blocks from the physical layer. The higher layer processor 1423 may send/acquire higher layer messages such as an RRC message and MAC message to/from a UE's higher layer. The higher layer processor 1423 may provide the PDSCH transmitter transport blocks and provide the PDCCH transmitter transmission parameters related to the transport blocks.

The DL transmitter 1425 may multiplex downlink physical channels and downlink physical signals (including reservation signal) and transmit them via transmission antennas 1431. The UL receiver 1433 may receive multiplexed uplink physical channels and uplink physical signals via receiving antennas 1431 and de-multiplex them. The PUCCH receiver 1435 may provide the higher layer processor 1423 UCI. The PUSCH receiver 1437 may provide the higher layer processor 1423 received transport blocks.

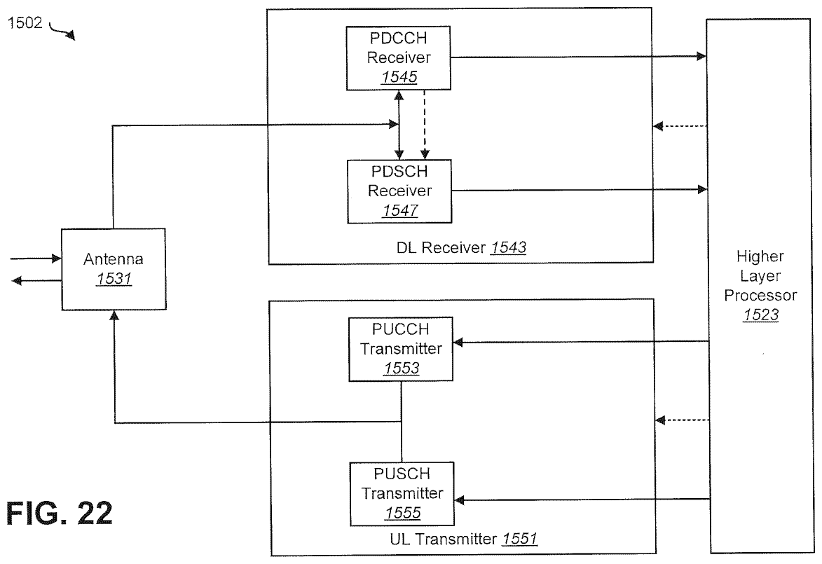

FIG. 22 is a block diagram illustrating one implementation of a UE 1502. The UE 1502 may be an example of the UE 102 described in connection with FIG. 1. The UE 1502 may include a higher layer processor 1523, a UL transmitter 1551, a DL receiver 1543, and one or more antenna 1531. The UL transmitter 1551 may include a PUCCH transmitter 1553 and a PUSCH transmitter 1555. The DL receiver 1543 may include a PDCCH receiver 1545 and a PDSCH receiver 1547.

The higher layer processor 1523 may manage physical layer's behaviors (the UL transmitter's and the DL receiver's behaviors) and provide higher layer parameters to the physical layer. The higher layer processor 1523 may obtain transport blocks from the physical layer. The higher layer processor 1523 may send/acquire higher layer messages such as an RRC message and MAC message to/from a UE's higher layer. The higher layer processor 1523 may provide the PUSCH transmitter transport blocks and provide the PUCCH transmitter 1553 UCI.

The DL receiver 1543 may receive multiplexed downlink physical channels and downlink physical signals via receiving antennas 1531 and de-multiplex them. The PDCCH receiver 1545 may provide the higher layer processor 1523 DCI. The PDSCH receiver 1547 may provide the higher layer processor 1523 received transport blocks.

The term “computer-readable medium” refers to any available medium that can be accessed by a computer or a processor. The term “computer-readable medium,” as used herein, may denote a computer-and/or processor-readable medium that is non-transitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray (Registered Trademark) disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

In one example, a network controlled repeater (NCR) comprising: receiving circuitry configured to: receive a cell specific common time division duplex (TDD) uplink/downlink (UL/DL) configuration and a side information with an NCR dedicated TDD UL/DL configuration; determine candidate slots for uplink (UL) reception on an access link, wherein the access link is for communications between the NCR and associated UE(s); receive an indication from a gNodeB (gNB) to receive an access uplink in a slot in the candidate slots for UL reception on the access link; receive UL transmissions in the slot on the access link, and buffer the receive UL slot for later forwarding to the gNB; determine slots for a backhaul link and/or a control link UL transmissions, wherein the backhaul link and/or the control link are for communications between the NCR and the gNB; receive an indication from the gNB to forward a buffered UL in the backhaul link and/or the control link UL slot; and transmitting circuitry configured to: transmit a previous buffered access link UL slot from a UE in the backhaul link and/or the control link UL slot.

In one example, the NCR, wherein the candidate slots for UL reception on the access link are determined by UL slots and flexible slots in the NCR dedicated TDD UL/DL configuration.

In one example, the NCR, wherein the slots for backhaul link and/or the control link UL are limited to the UL and flexible slots in the cell specific common TDD UL/DL configuration that do not overlap with the NCR dedicated TDD UL/DL configuration, and wherein the NCR is not expected to transmit an UL to the gNB in a slot within the NCR dedicated TDD UL/DL configuration; if an indication to forward an access UL in the backhaul link and/or the control link UL slot is received, the NCR transmits a buffered UL from the access link to the gNB in the backhaul link and/or the control link UL; and if an UL transmission is scheduled from the gNB in the backhaul link and/or the control link UL slot, the NCR transmits the scheduled UL to the gNB in the backhaul link and/or the control link UL.

In one example, the NCR, wherein the slots for the backhaul link and/or the control link UL are determined by the UL slots and flexible slots in the cell specific common TDD UL/DL configuration only, and if an indication to forward an access UL in the backhaul link and/or the control link UL slot is received, the NCR transmits a buffered UL from the access link to the gNB in the backhaul link and/or the control link UL; if an UL transmission is scheduled from the gNB in the backhaul link and/or the control link UL slot, the NCR transmits the scheduled UL to the gNB in the backhaul link and/or the control link UL; and if the backhaul link and/or the control link UL slot is also a candidate slot for UL reception on the access link, and if an indication to receive an UL on the access link is received, the NCR receives UL transmissions in the slot on the access link and buffers the received UL signal.

In one example, a gNodeB (gNB) comprising: transmitting circuitry configured to: transmit a cell specific common time division duplex (TDD) uplink/downlink (UL/DL) configuration and a side information with a network controlled repeater (NCR) dedicated TDD UL/DL configuration; determine candidate slots for uplink (UL) reception on an access link, wherein the access link is for communications between the NCR and associated UE(s); transmit an indication to the NCR to receive an access uplink in a slot in the candidate slots for UL reception on the access link; transmit UL transmissions in the slot on the access link; determine slots for a backhaul link and/or a control link UL transmissions, wherein the backhaul link and/or the control link are for communications between the NCR and the gNB; transmit an indication to the NCR to forward a buffered UL in the backhaul link and/or the control link UL slot; and receiving circuitry configured to: receive a previously buffered access link UL slot from a UE in the backhaul link and/or the control link UL slot.

In one example, the gNB, wherein the candidate slots for UL reception on the access link are determined by UL slots and flexible slots in the NCR dedicated TDD UL/DL configuration.

In one example, the gNB, wherein the slots for backhaul link and/or the control link UL are limited to the UL and flexible slots in the cell specific common TDD UL/DL configuration that do not overlap with the NCR dedicated TDD UL/DL configuration, and wherein if an indication to forward an access UL in the backhaul link and/or the control link UL slot is transmitted, receive from the NCR a buffered UL from the access link in the backhaul link and/or the control link UL; and if an UL transmission is scheduled from the gNB in the backhaul link and/or the control link UL slot, receive from the NCR the scheduled UL in the backhaul link and/or the control link UL.

In one example, the gNB, wherein the slots for the backhaul link and/or the control link UL are determined by the UL slots and flexible slots in the cell specific common TDD UL/DL configuration only, and if an indication to forward an access UL in the backhaul link and/or the control link UL slot is transmitted, receive from the NCR a buffered UL from the access link in the backhaul link and/or the control link UL; if an UL transmission is scheduled from the gNB in the backhaul link and/or the control link UL slot, receive from the NCR the scheduled UL in the backhaul link and/or the control link UL; and if the backhaul link and/or the control link UL slot is also a candidate slot for UL reception on the access link, and if an indication to receive an UL on the access link is transmitted, transmit to the NCR UL transmissions in the slot on the access link and buffers the received UL signal.

In one example, a communication method of a network controlled repeater (NCR), comprising: receiving a cell specific common time division duplex (TDD) uplink/downlink (UL/DL) configuration and a side information with an NCR dedicated TDD UL/DL configuration; determining candidate slots for uplink (UL) reception on an access link, wherein the access link is for communications between the NCR and associated UE(s); receiving an indication from a gNodeB (gNB) to receive an access uplink in a slot in the candidate slots for UL reception on the access link; receiving UL transmissions in the slot on the access link, and buffer the receive UL slot for later forwarding to the gNB; determining slots for a backhaul link and/or a control link UL transmissions, wherein the backhaul link and/or the control link are for communications between the NCR and the gNB; receiving an indication from the gNB to forward a buffered UL in the backhaul link and/or the control link UL slot; and transmitting a previous buffered access link UL slot from a UE in the backhaul link and/or the control link UL slot.

In one example, the NCR, if an indication to receive an UL on the access link is received, the NCR receives UL transmissions in the slot on the access link and buffers the received UL signal.

In one example, the NCR, if an indication to forward an access UL on the backhaul link and/or the control link UL slot is received, the NCR transmits a buffered UL from the access link to the gNB in the indicated uplink slot for backhaul link and/or the control link.

In one example, the gNB, the gNB indicates an UL slot on the access link, where the NCR receives UL transmissions in the slot on the access link and buffers the received UL signal.

In one example, the gNB, the gNB indicates an UL slot on the backhaul link for the NCR to forward an access UL on the backhaul link; and receives the buffered UL from the NCR in the indicated access link uplink slot.

### CROSS REFERENCE

This Nonprovisional application claims priority under 35 U.S.C. § 119 on provisional Application No. 63/396,898 on Aug. 10, 2022, the entire contents of which are hereby incorporated by reference.

1. A network controlled repeater (NCR) comprising:
receiving circuitry configured to:
receive a cell specific common time division duplex (TDD) uplink/downlink (UL/DL) configuration and a side information with an NCR dedicated TDD UL/DL configuration;
determine candidate slots for uplink (UL) reception on an access link, wherein the access link is for communications between the NCR and associated UE(s);
receive an indication from a gNodeB (gNB) to receive an access uplink in a slot in the candidate slots for UL reception on the access link;
receive UL transmissions in the slot on the access link, and buffer the receive UL slot for later forwarding to the gNB;
determine slots for a backhaul link and/or a control link UL transmissions, wherein the backhaul link and/or the control link are for communications between the NCR and the gNB;
receive an indication from the gNB to forward a buffered UL in the backhaul link and/or the control link UL slot; and
transmitting circuitry configured to:
transmit a previous buffered access link UL slot from a UE in the backhaul link and/or the control link UL slot.

2. The NCR of claim 1, if an indication to receive an UL on the access link is received, the NCR receives UL transmissions in the slot on the access link and buffers the received UL signal.

3. The NCR of claim 1, if an indication to forward an access UL on the backhaul link and/or the control link UL slot is received, the NCR transmits a buffered UL from the access link to the gNB in the indicated uplink slot for backhaul link and/or the control link.

4. A gNodeB (gNB) comprising:
transmitting circuitry configured to:
transmit a cell specific common time division duplex (TDD) uplink/downlink (UL/DL) configuration and a side information with a network controlled repeater (NCR) dedicated TDD UL/DL configuration;
determine candidate slots for uplink (UL) reception on an access link, wherein the access link is for communications between the NCR and associated UE(s);
transmit an indication to the NCR to receive an access uplink in a slot in the candidate slots for UL reception on the access link;
transmit UL transmissions in the slot on the access link;
determine slots for a backhaul link and/or a control link UL transmissions, wherein the backhaul link and/or the control link are for communications between the NCR and the gNB;
transmit an indication to the NCR to forward a buffered UL in the backhaul link and/or the control link UL slot; and
receiving circuitry configured to:
receive a previously buffered access link UL slot from a UE in the backhaul link and/or the control link UL slot.

5. The gNB of claim 4, the gNB indicates an UL slot on the access link, where the NCR receives UL transmissions in the slot on the access link and buffers the received UL signal.

6. The gNB of claim 4, the gNB indicates an UL slot on the backhaul link for the NCR to forward an access UL on the backhaul link; and
receives the buffered UL from the NCR in the indicated access link uplink slot.

7. A communication method of a network controlled repeater (NCR), comprising:
receiving a cell specific common time division duplex (TDD) uplink/downlink (UL/DL) configuration and a side information with an NCR dedicated TDD UL/DL configuration;
determining candidate slots for uplink (UL) reception on an access link, wherein the access link is for communications between the NCR and associated UE(s);
receiving an indication from a gNodeB (gNB) to receive an access uplink in a slot in the candidate slots for UL reception on the access link;
receiving UL transmissions in the slot on the access link, and buffer the receive UL slot for later forwarding to the gNB;
determining slots for a backhaul link and/or a control link UL transmissions, wherein the backhaul link and/or the control link are for communications between the NCR and the gNB;
receiving an indication from the gNB to forward a buffered UL in the backhaul link and/or the control link UL slot; and
transmitting a previous buffered access link UL slot from a UE in the backhaul link and/or the control link UL slot.
